(19) United States
(12) Patent Application Publication
(10) Pub. No.: US 2025/0286694 A1
(43) Pub. Date: Sep. 11, 2025

(54) CONNECTED MODE RACH OCCASIONS MULTIPLEXING RULE WITH CLI CONSIDERATION

(71) Applicant: QUALCOMM Incorporated, San Diego, CA (US)

(72) Inventors: Qian ZHANG, Basking Ridge, NJ (US); Yan ZHOU, San Diego, CA (US); Muhammad Sayed Khairy ABDELGHAFFAR, San Jose, CA (US)

(21) Appl. No.: 18/600,592

(22) Filed: Mar. 8, 2024

(51) Int. Cl. H04L 5/14; H04L 5/00; H04W 72/541; H04W 74/0838

(52) U.S. Cl. CPC H04L 5/1461; H04L 5/0053; H04W 72/541; H04W 74/0838

(57) ABSTRACT

The apparatus may be a UE configured to receive time and frequency information for SBFD resources, receive a random access configuration for random access in the SBFD resources, and transmit, based on meeting one or more conditions of a random access event trigger condition, a power condition, a UE type condition, or a conflicting signal condition, a random access message in a random access occasion (RO) in an uplink sub-band of an SBFD time period. The apparatus may be a network device configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition.

### INTRODUCTION

The present disclosure relates generally to communication systems, and more particularly, to a random access channel (RACH) process associated with sub-band full-duplex (SBFD) operation.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In some aspects, the techniques described herein relate to an apparatus for wireless communication at a user equipment (UE), including: one or more memories; and one or more processors coupled to the one or more memories and configured to cause the UE to: receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a random access occasion (RO) in an uplink sub-band of an SBFD time period.

In some aspects, the techniques described herein relate to a method of wireless communication at a UE, including: receiving time and frequency information for SBFD resources, receiving at least one random access configuration for random access in the SBFD resources, and transmitting, based on meeting one or more conditions of a random access event trigger condition, a power condition, a UE type condition, or a conflicting signal condition, a random access message in a RO in an uplink sub-band of an SBFD time period.

In some aspects, the techniques described herein relate to an apparatus for wireless communication at a UE, including: means for receiving time and frequency information for SBFD resources, receiving at least one random access configuration for random access in the SBFD resources, and transmitting, based on meeting one or more conditions of a random access event trigger condition, a power condition, a UE type condition, or a conflicting signal condition, a random access message in a RO in an uplink sub-band of an SBFD time period.

In an aspect of the disclosure, a computer-readable storage medium is provided. The computer-readable medium stores computer executable code at a UE, the code when executed by one or more processors causes the UE to: receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period.

In some aspects, the techniques described herein relate to an apparatus for wireless communication at a network node, including: one or more memories; and one or more processors coupled to the one or more memories and configured to cause the network node to: provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

In some aspects, the techniques described herein relate to a method of wireless communication at a network node, including: providing time and frequency information for SBFD resources and providing at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

In some aspects, the techniques described herein relate to an apparatus for wireless communication at a network node, including: means for providing time and frequency information for SBFD resources and providing at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

In an aspect of the disclosure, a computer-readable storage medium is provided. The computer-readable medium stores computer executable code at a network node, the code when executed by one or more processors causes the network node to: provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

In an aspect of the disclosure, a method, a computer-readable medium, and an apparatus are provided. The apparatus may be a network device or base station configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network (NW), in accordance with various aspects of the present disclosure.

FIG. 2 shows a diagram illustrating architecture of an example of a disaggregated base station, in accordance with various aspects of the present disclosure.

FIG. 3A is a diagram illustrating an example of a first subframe within a frame structure, in accordance with various aspects of the present disclosure.

FIG. 3B is a diagram illustrating an example of downlink (DL) channels within a subframe, in accordance with various aspects of the present disclosure.

FIG. 3C is a diagram illustrating an example of a second subframe within a frame structure, in accordance with various aspects of the present disclosure.

FIG. 3D is a diagram illustrating an example of uplink (UL) channels within a subframe, in accordance with various aspects of the present disclosure.

FIG. 4 is a block diagram illustrating an example of a network node in communication with a UE in an access network, in accordance with various aspects of the present disclosure.

FIG. 5A shows a first example of full duplex communication.

FIG. 5B shows a second example of full-duplex communication.

FIG. 5C shows a third example of full-duplex communication.

FIG. 5D shows the fourth example of full-duplex communication.

FIG. 6 illustrates a first example and a second example of in-band full-duplex (IBFD) resources and a third example of SBFD resources.

FIG. 7 is a diagram illustrating an example of the network SBFD operation.

FIG. 8 is a diagram illustrating example slots and/or symbols for SBFD operation in accordance with various aspects of the present disclosure.

FIG. 9A is a diagram illustrating a set of RACH occasions that may be configured within UL resources in accordance with some aspects of the disclosure.

FIG. 9B is a diagram illustrating power-related thresholds that may be applied in accordance with some aspects of the disclosure.

FIG. 9C illustrates example aspects of random access in accordance with some aspects of the disclosure.

FIG. 10 is a diagram illustrating that some SBFD ROs may be invalid when overlapping fully, or partially, with one or more DL transmissions in accordance with some aspects of the disclosure.

FIG. 11 is a call flow diagram illustrating a method of using SBFD ROs in accordance with some aspects of the disclosure.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

FIG. 17A, FIG. 17B, and FIG. 17C illustrate examples of repetition of random access messages in accordance with some aspects of the disclosure.

### DETAILED DESCRIPTION

In some aspects of wireless communication, a sub-band full-duplex mode of operation may be used in which a portion of a bandwidth in a DL (or flexible) slot or symbol may be used for UL (or vice versa). The ability to transmit UL transmissions during what would otherwise be a DL slot may reduce latency, improve UL coverage, enhance system capacity/resource utilization/spectrum efficiency, enable flexible and dynamic UL/DL resource adaption according to UL/DL traffic in a robust manner. The UL transmissions, in some aspects, may include random access (e.g., associated with a random access channel or RACH) messages. If random access is allowed in SBFD slots and/or symbols for SBFD-aware UEs (e.g., UEs that are aware of the network's operation in the SBFD mode), it may potentially reduce the random access latency, reduce the physical RACH (PRACH) collision probability and/or improve the coverage of PRACH and Msg3. However, RACH (e.g., PRACH and Msg3) transmissions in the UL sub-band in SBFD symbols may cause UE-to-UE cross link interference (CLI).

Various aspects relate generally to limiting UE-to-UE CLI associated with the use of SBFD ROs. Some aspects more specifically relate to different options to specify RACH occasion behavior for connected UEs within SBFD symbols. For example, some options may be summarized as allowing connected UEs to use SBFD ROs, using controlled PRACH (e.g., PDCCH ordered PRACH), specifying behaviors of non-SBFD-capable UEs, limiting PRACH transmit power, and limiting power by applying a minimum RSRP for a DL transmission before an SBFD-capable UE may use SBFD ROs. In some examples, a wireless device or UE configured to receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period. In some examples, a network device or base station configured to provide time and frequency information for SBFD resources and provide at least one random access configuration for random access in the SBFD resources, where the random access configuration is associated with one or more conditions of a random access event trigger condition, a power condition, or a conflicting signal condition.

Particular aspects of the subject matter described in this disclosure can be implemented to realize one or more of the following potential advantages. In some examples, by configuring the use of SBFD ROs, the described techniques can be used to enhance UL coverage, reduce RACH collision probability, reduce random access latency.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

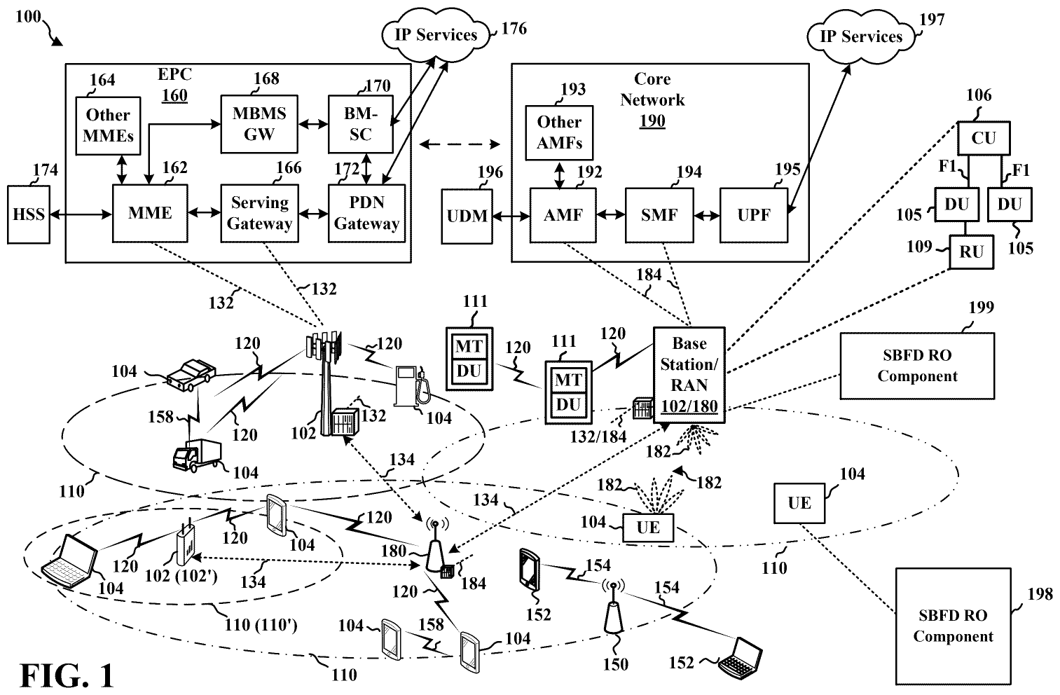

FIG. 1 is a diagram illustrating an example of a wireless communications system and an access network 100. The wireless communications system (also referred to as a wireless wide area network (WWAN)) includes base stations 102, UEs 104, an Evolved Packet Core (e.g., an EPC 160), and another core network 190 (e.g., a 5G Core (5GC)). The base stations 102 may include macrocells (high power cellular base station) and/or small cells (low power cellular base station). The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station (e.g., one of the base stations 102 or one of base stations 180) may be referred to as a RAN and may include aggregated or disaggregated components. As an example of a disaggregated RAN, a base station may include a central unit (CU) (e.g., a CU 106), one or more distributed units (DU) (e.g., a DU 105), and/or one or more remote units (RU) (e.g., an RU 109), as illustrated in FIG. 1. A RAN may be disaggregated with a split between the RU 109 and an aggregated CU/DU. A RAN may be disaggregated with a split between the CU 106, the DU 105, and the RU 109. A RAN may be disaggregated with a split between the CU 106 and an aggregated DU/RU. The CU 106 and the one or more DUs may be connected via an F1 interface. A DU 105 and an RU 109 may be connected via a fronthaul interface. A connection between the CU 106 and a DU 105 may be referred to as a midhaul, and a connection between a DU 105 and the RU 109 may be referred to as a fronthaul. The connection between the CU 106 and the core network 190 may be referred to as the backhaul.

The RAN may be based on a functional split between various components of the RAN, e.g., between the CU 106, the DU 105, or the RU 109. The CU 106 may be configured to perform one or more aspects of a wireless communication protocol, e.g., handling one or more layers of a protocol stack, and the one or more DUs may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. The CU 106 may host higher layer functions, e.g., above the RLC layer, such as a service data adaptation protocol (SDAP) layer, a packet data convergence protocol (PDCP) layer, and/or an upper layer. In other implementations, the split between the layer functions provided by the CU, the DU, or the RU may be different.

The base stations 102 may wirelessly communicate with the UEs 104. Each of the base stations 102 may provide communication coverage for a respective geographic coverage area 110. There may be overlapping geographic coverage areas. For example, a small cell may have a coverage area 111 that overlaps the respective geographic coverage area 110 of one or more base stations (e.g., one or more macro base stations, such as the base stations 102). A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE to a base station and/or downlink (DL) (also referred to as forward link) transmissions from a base station to a UE. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs may communicate with each other using device-to-device (D2D) communication links, such as a D2D communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE), Wi-Fi based on the IEEE 802.11 standard, LTE, or NR.

The wireless communications system may further include a Wi-Fi access point (AP), such as an AP 150, in communication with Wi-Fi stations (STAs), such as STAs 152, via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell may operate in a licensed and/or an unlicensed frequency spectrum. When operating in an unlicensed frequency spectrum, the small cell may employ NR and use the same unlicensed frequency spectrum (e.g., 5 GHz, or the like) as used by the AP 150. The small cell, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

A base station, whether a small cell or a large cell (e.g., a macro base station), may include and/or be referred to as an eNB, gNodeB (gNB), or another type of base station. Some base stations, such as a gNB, may operate in a traditional sub 6 GHz spectrum, in millimeter wave frequencies, and/or near millimeter wave frequencies in communication with the UEs 104. When the gNB operates in millimeter wave or near millimeter wave frequencies, the base stations 180 may be referred to as a millimeter wave base station. A millimeter wave base station may utilize beamforming 182 with the UEs 104 to compensate for the path loss and short range. The base stations 180 and the UEs 104 may each include a plurality of antennas, such as antenna elements, antenna panels, and/or antenna arrays to facilitate the beamforming.

The base stations 180 may transmit a beamformed signal to the UEs 104 in one or more transmit directions. The UEs 104 may receive the beamformed signal from the base stations 180 in one or more receive directions. The UEs 104 may also transmit a beamformed signal to the base stations 180 in one or more transmit directions. The base stations 180 may receive the beamformed signal from the UEs 104 in one or more receive directions. The base stations 180/UEs 104 may perform beam training to determine the best receive and transmit directions for each of the base stations 180/UEs 104. The transmit and receive directions for the base stations 180 may or may not be the same. The transmit and receive directions for the UEs 104 may or may not be the same.

The EPC 160 may include a Mobility Management Entity (e.g., an MME 162), other MMEs 164, a Serving Gateway 166, a Multimedia Broadcast Multicast Service (MBMS) Gateway (e.g., a MBMS Gateway 168), a Broadcast Multicast Service Center (BM-SC) (e.g., a BM-SC 170), and a Packet Data Network (PDN) Gateway (e.g., a PDN Gateway 172). The MME 162 may be in communication with a Home Subscriber Server (HSS) (e.g., an HSS 174). The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) (e.g., an AMF 192), other AMFs 193, a Session Management Function (SMF) 194, and a User Plane Function (UPF) (e.g., a UPF 195). The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base stations 102 may include and/or be referred to as a gNB, Node B, eNB, an access point, a base transceiver station, a radio base station, a radio transceiver, a transceiver function, a basic service set (BSS), an extended service set (ESS), a transmission reception point (TRP), network node, network entity, network equipment, or some other suitable terminology. The base stations 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN). The base stations 102 provide an access point to the EPC 160 or core network 190 for the UEs 104.

A non-terrestrial network (NTN) may refer to a wireless communication system that utilizes satellite nodes (which may be referred to as NTN nodes), in order to provide wireless communication services to UEs. In an example, a UE may transmit first data and/or first signal(s) to a satellite via a service link and the satellite node may provide or relay the first data and/or the first signal(s) to a terrestrial network node (e.g., a base station) via a feeder link and/or via a gateway. The terrestrial network node may transmit second data and/or second signal(s) to the satellite node via the feeder link and the satellite may relay the second data and/or the second signal(s) to the UE via the service link.

Examples of UEs include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs may be referred to as IoT devices (e.g., parking meter, gas pump, toaster, vehicles, heart monitor, etc.). The UEs may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an SBFD RO component 198 that may be configured to receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period. In certain aspects, the base station 102 may have an SBFD RO component 199 that may be configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period. Although the following description may be focused on 5G NR, the concepts described herein may be applicable to other similar areas, such as LTE, LTE-A, CDMA, GSM, and other wireless technologies.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

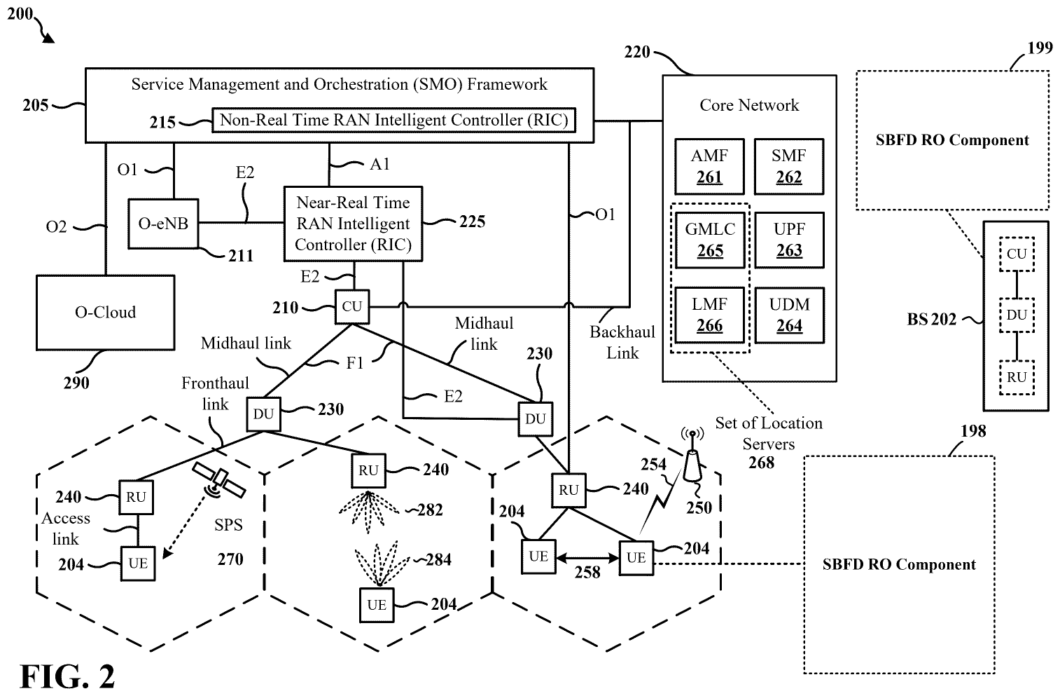

As an example, FIG. 2 shows a diagram illustrating architecture of an example of a disaggregated base station 200. The architecture of the disaggregated base station 200 may include one or more CUs (e.g., a CU 210) that can communicate directly with a core network 220 via a backhaul link, or indirectly with the core network 220 through one or more disaggregated base station units (such as a Near-Real Time (Near-RT) RAN Intelligent Controller (RIC) (e.g., a Near-RT RIC 225) via an E2 link, or a Non-Real Time (Non-RT) RIC (e.g., a Non-RT RIC 215) associated with a Service Management and Orchestration (SMO) Framework (e.g., an SMO Framework 205), or both). A CU 210 may communicate with one or more DUs (e.g., a DU 230) via respective midhaul links, such as an F1 interface. The DU 230 may communicate with one or more RUs (e.g., an RU 240) via respective fronthaul links. The RU 240 may communicate with respective UEs (e.g., a UE 204) via one or more radio frequency (RF) access links. In some implementations, the UE 204 may be simultaneously served by multiple RUs.

Each of the units, i.e., the CUs (e.g., a CU 210), the DUs (e.g., a DU 230), the RUs (e.g., an RU 240), as well as the Near-RT RICs (e.g., the Near-RT RIC 225), the Non-RT RICs (e.g., the Non-RT RIC 215), and the SMO Framework 205, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (i.e., Central Unit-User Plane (CU-UP)), control plane functionality (i.e., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as an E1 interface when implemented in an O-RAN configuration. The CU 210 can be implemented to communicate with the DU 230, as necessary, for network control and signaling.

The DU 230 may correspond to a logical unit that includes one or more base station functions to control the operation of one or more RUs. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU 240 can be implemented to handle over the air (OTA) communication with one or more UEs (e.g., the UE 204). In some implementations, real-time and non-real-time aspects of control and user plane communication with the RU 240 can be controlled by a corresponding DU. In some scenarios, this configuration can enable the DU(s) and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements that may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs, DUs, RUs and Near-RT RICs. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more RUs via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs, one or more DUs, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

At least one of the CU 210, the DU 230, and the RU 240 may be referred to as a base station 202. Accordingly, a base station 202 may include one or more of the CU 210, the DU 230, and the RU 240 (each component indicated with dotted lines to signify that each component may or may not be included in the base station 202). The base station 202 provides an access point to the core network 220 for a UE 204. The communication links between the RUs (e.g., the RU 240) and the UEs (e.g., the UE 204) may include uplink (UL) (also referred to as reverse link) transmissions from a UE 204 to an RU 240 and/or downlink (DL) (also referred to as forward link) transmissions from an RU 240 to a UE 204.

Certain UEs may communicate with each other using D2D communication (e.g., a D2D communication link 258). The D2D communication link 258 may use the DL/UL WWAN spectrum. The D2D communication link 258 may use one or more sidelink channels. D2D communication may be through a variety of wireless D2D communications systems, such as for example, Bluetooth, Wi-Fi based on the IEEE 802.11 standard, LTE, or NR.

The wireless communications system may further include a Wi-Fi AP 250 in communication with a UE 204 (also referred to as Wi-Fi STAs) via communication link 254, e.g., in a 5 GHz unlicensed frequency spectrum or the like. When communicating in an unlicensed frequency spectrum, the UE 204/Wi-Fi AP 250 may perform a CCA prior to communicating in order to determine whether the channel is available.

The base station 202 and the UE 204 may each include a plurality of antennas, such as antenna elements, antenna panels, and/or antenna arrays to facilitate beamforming. The base station 202 may transmit a beamformed signal 282 to the UE 204 in one or more transmit directions. The UE 204 may receive the beamformed signal from the base station 202 in one or more receive directions. The UE 204 may also transmit a beamformed signal 284 to the base station 202 in one or more transmit directions. The base station 202 may receive the beamformed signal from the UE 204 in one or more receive directions. The base station 202/UE 204 may perform beam training to determine the best receive and transmit directions for each of the base station 202/UE 204. The transmit and receive directions for the base station 202 may or may not be the same. The transmit and receive directions for the UE 204 may or may not be the same.

The core network 220 may include an Access and Mobility Management Function (AMF) (e.g., an AMF 261), a Session Management Function (SMF) (e.g., an SMF 262), a User Plane Function (UPF) (e.g., a UPF 263), a Unified Data Management (UDM) (e.g., a UDM 264), one or more location servers 268, and other functional entities. The AMF 261 is the control node that processes the signaling between the UEs and the core network 220. The AMF 261 supports registration management, connection management, mobility management, and other functions. The SMF 262 supports session management and other functions. The UPF 263 supports packet routing, packet forwarding, and other functions. The UDM 264 supports the generation of authentication and key agreement (AKA) credentials, user identification handling, access authorization, and subscription management. The one or more location servers 268 are illustrated as including a Gateway Mobile Location Center (GMLC) (e.g., a GMLC 265) and a Location Management Function (LMF) (e.g., an LMF 266). However, generally, the one or more location servers 268 may include one or more location/positioning servers, which may include one or more of the GMLC 265, the LMF 266, a position determination entity (PDE), a serving mobile location center (SMLC), a mobile positioning center (MPC), or the like. The GMLC 265 and the LMF 266 support UE location services. The GMLC 265 provides an interface for clients/applications (e.g., emergency services) for accessing UE positioning information. The LMF 266 receives measurements and assistance information from the NG-RAN and the UE 204 via the AMF 261 to compute the position of the UE 204. The NG-RAN may utilize one or more positioning methods in order to determine the position of the UE 204. Positioning the UE 204 may involve signal measurements, a position estimate, and an optional velocity computation based on the measurements. The signal measurements may be made by the UE 204 and/or the base station 202 serving the UE 204. The signals measured may be based on one or more of a satellite positioning system (SPS) 270 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Referring again to FIG. 2, in some aspects, the UE 204, similar to the UE 104 in FIG. 1, may have an SBFD RO component 198 configured to receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period.

In some aspects, a network node such as a base station 202, or one or more components of the base station 202, may include an SBFD RO component 199 configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period.

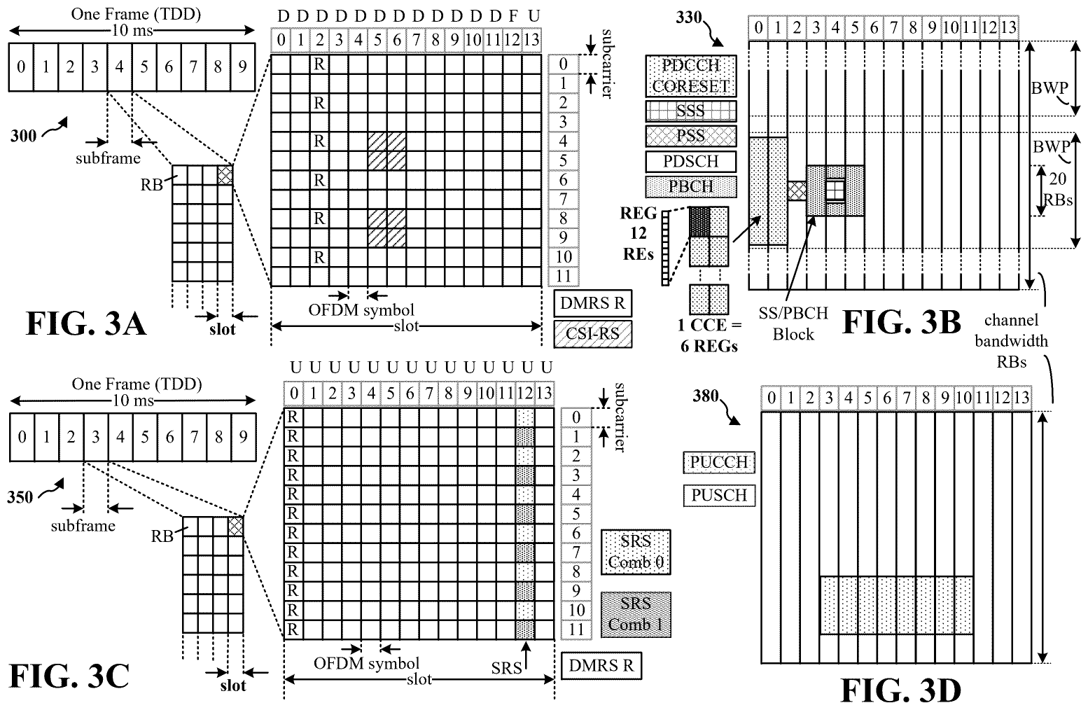

FIG. 3A is a diagram 300 illustrating an example of a first subframe within a 5G NR frame structure. FIG. 3B is a diagram 330 illustrating an example of DL channels within a 5G NR subframe. FIG. 3C is a diagram 350 illustrating an example of a second subframe within a 5G NR frame structure. FIG. 3D is a diagram 380 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 3A, 3C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 3A-3D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. As shown in Table 1, the subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 3A-3D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 3B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The PDCCH carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE, such as one of the UEs 104 of FIG. 1 and/or the UE 204 of FIG. 2, to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The PDSCH carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

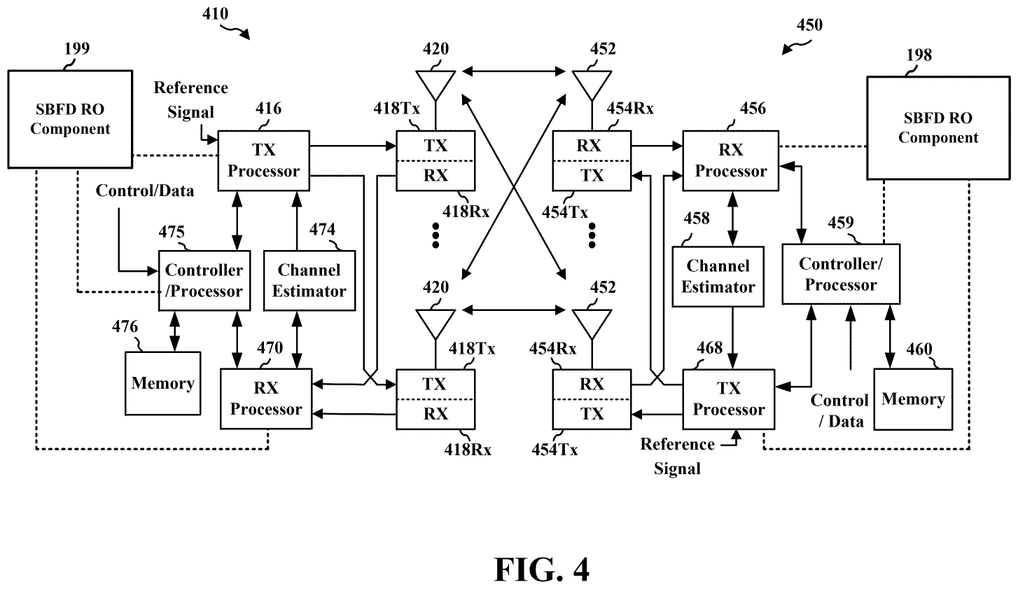

FIG. 4 is a block diagram that illustrates an example of a first wireless device that is configured to exchange wireless communication with a second wireless device. In the illustrated example of FIG. 4, the first wireless device may include a network node such as base station 410, one or more components of a disaggregated base station, or an NTN node such as a satellite based node. The second wireless device may include a UE 450. In an example in which the second wireless device is a base station, the base station 410 may be in communication with the UE 450 in an access network. As shown in FIG. 4, the base station 410 includes a transmit processor (TX processor 416), a transmitter 418Tx, a receiver 418Rx, antennas 420, a receive processor (RX processor 470), a channel estimator 474, a controller/processor 475, and at least one memory 476 (e.g., one or more memories). The example UE 450 includes antennas 452, a transmitter 454Tx, a receiver 454Rx, an RX processor 456, a channel estimator 458, a controller/processor 459, at least one memory 460 (e.g., one or more memories), and a TX processor 468. In other examples, the base station 410 and/or the UE 450 may include additional or alternative components.

In the DL, Internet protocol (IP) packets may be provided to the controller/processor 475. The controller/processor 475 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 475 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The TX processor 416 and the RX processor 470 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 416 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from the channel estimator 474 may be used to determine the coding and modulation scheme, as well as for spatial processing. The channel estimate may be derived from a reference signal and/or channel condition feedback transmitted by the UE 450. Each spatial stream may then be provided to a different antenna of the antennas 420 via a separate transmitter (e.g., the transmitter 418Tx). Each transmitter 418Tx may modulate a radio frequency (RF) carrier with a respective spatial stream for transmission.

At the UE 450, each receiver 454Rx receives a signal through its respective antenna of the antennas 452. Each receiver 454Rx recovers information modulated onto an RF carrier and provides the information to the RX processor 456. The TX processor 468 and the RX processor 456 implement layer 1 functionality associated with various signal processing functions. The RX processor 456 may perform spatial processing on the information to recover any spatial streams destined for the UE 450. If multiple spatial streams are destined for the UE 450, two or more of the multiple spatial streams may be combined by the RX processor 456 into a single OFDM symbol stream. The RX processor 456 then converts the OFDM symbol stream from the time domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 410. These soft decisions may be based on channel estimates computed by the channel estimator 458. The soft decisions are then decoded and deinterleaved to recover the data and control signals that were originally transmitted by the base station 410 on the physical channel. The data and control signals are then provided to the controller/processor 459, which implements layer 3 and layer 2 functionality.

The controller/processor 459 can be associated with the at least one memory 460 that stores program codes and data. The at least one memory 460 may be referred to as a computer-readable medium. In the UL, the controller/processor 459 provides demultiplexing between transport and logical channels, packet reassembly, deciphering, header decompression, and control signal processing to recover IP packets. The controller/processor 459 is also responsible for error detection using an ACK and/or NACK protocol to support HARQ operations.

Similar to the functionality described in connection with the DL transmission by the base station 410, the controller/processor 459 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by the channel estimator 458 from a reference signal or feedback transmitted by the base station 410 may be used by the TX processor 468 to select the appropriate coding and modulation schemes, and to facilitate spatial processing. The spatial streams generated by the TX processor 468 may be provided to different antenna of the antennas 452 via separate transmitters (e.g., the transmitter 454Tx). Each transmitter 454Tx may modulate an RF carrier with a respective spatial stream for transmission.

The UL transmission is processed at the base station 410 in a manner similar to that described in connection with the receiver function at the UE 450. Each receiver 418Rx receives a signal through its respective antenna of the antennas 420. Each receiver 418Rx recovers information modulated onto an RF carrier and provides the information to the RX processor 470.

The controller/processor 475 can be associated with the at least one memory 476 that stores program codes and data. The at least one memory 476 may be referred to as a computer-readable medium. In the UL, the controller/processor 475 provides demultiplexing between transport and logical channels, packet reassembly, deciphering, header decompression, control signal processing to recover IP packets. The controller/processor 475 is also responsible for error detection using an ACK and/or NACK protocol to support HARQ operations.

At least one of the TX processor 468, the RX processor 456, and the controller/processor 459 may be configured to perform aspects in connection with the SBFD RO component 198 of FIG. 1.

At least one of the TX processor 416, the RX processor 470, and the controller/processor 475 may be configured to perform aspects in connection with the SBFD RO component 199 of FIG. 1.

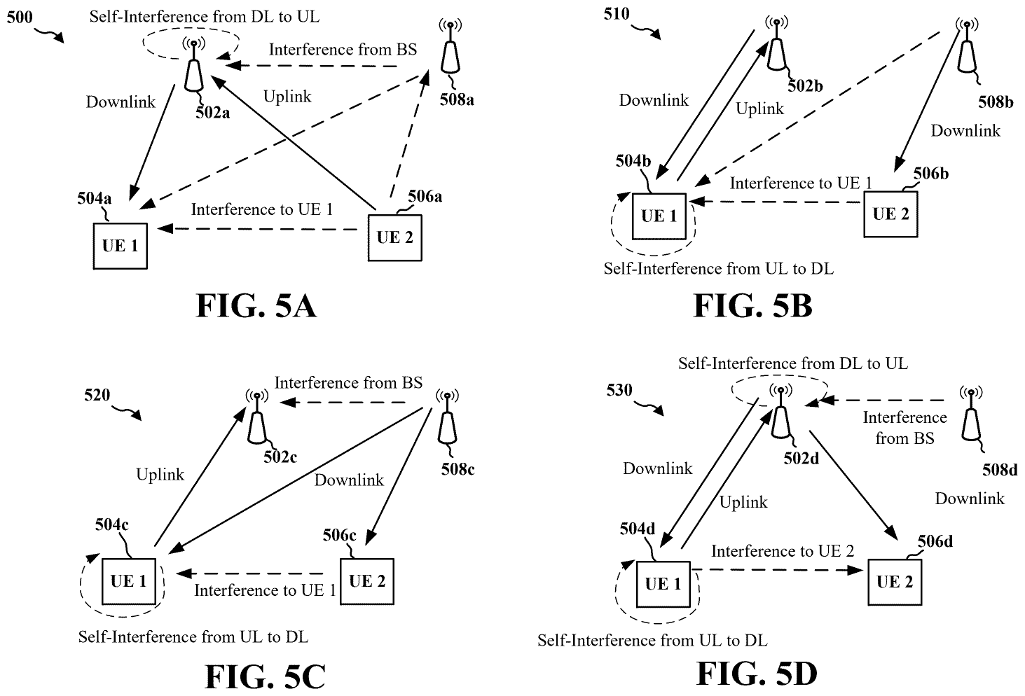

FIGS. 5A, 5B, 5C, and 5D illustrate various modes of full-duplex communication and interference that may be experienced by one or more devices. Full-duplex communication supports transmission and reception of information over a same frequency band in a manner that overlaps in time. In this manner, spectral efficiency may be improved with respect to the spectral efficiency of half-duplex communication, which supports transmission or reception of information in one direction at a time without overlapping uplink and downlink communication. Due to the simultaneous Tx/Rx nature of full-duplex communication, a UE or a base station may experience self-interference caused by signal leakage from its local transmitter to its local receiver. In addition, the UE or base station may also experience interference from other devices, such as transmissions from a second UE or a second base station. Such interference (e.g., self-interference or interference caused by other devices) may impact the quality of the communication, or even lead to a loss of information.

FIG. 5A shows a first example of full duplex communication 500 in which a first base station 502a is in full duplex communication with a first UE 504a and a second UE 506a. The first UE 504a and the second UE 506a may be configured for half-duplex communication or full-duplex communication. FIG. 5A illustrates the first UE 504a performing downlink reception, and the second UE 506a performing uplink transmission. The second UE 506a may transmit a first uplink signal to the first base station 502a as well as to other base stations, such as a second base station 508a in proximity to the second UE 506a. The first base station 502a transmits a downlink signal to the first UE 504a concurrently (e.g., overlapping at least partially in time) with receiving the uplink signal from the second UE 506a. The base station 502a may experience self-interference at its receiving antenna that is receiving the uplink signal from UE 506a, the self-interference being due to reception of at least part of the downlink signal transmitted to the UE 504a. The base station 502a may experience additional interference due to signals from the second base station 508a. Interference may also occur at the first UE 504a based on signals from the second base station 508a as well as from uplink signals from the second UE 506a (as an example of UE-to-UE CLI).

FIG. 5B shows a second example of full-duplex communication 510 in which a first base station 502b is in full-duplex communication with a first UE 504b. In this example, the UE 504b is also operating in a full-duplex mode. The first base station 502b and the UE 504b receive and transmit communication that overlaps in time and is in a same frequency band. The base station 502b and the UE 504b may each experience self-interference, due to a transmitted signal from the device leaking to (e.g., being received by) a receiver at the same device. The first UE 504b may experience additional interference based on one or more signals emitted from a second UE 506b and/or a second base station 508b in proximity to the first UE 504b.

FIG. 5C shows a third example of full-duplex communication 520 in which a first UE 504c transmits and receives full-duplex communication with a first base station 502c and a second base station 508c. The first base station 502c and the second base station 508c may serve as multiple transmission and reception points (multi-TRPs) for UL and DL communication with the UE 504c. The second base station 508c may also exchange communication with a second UE 506c. In FIG. 5C, the first UE 504c may transmit an uplink signal to the first base station 502c that overlaps in time with receiving a downlink signal from the second base station 508c. The first UE 504c may experience self-interference as a result of receiving at least a portion of the first signal when receiving the second signal, e.g., the UE's uplink signal to the base station 502c may leak to (e.g., be received by) the UE's receiver when the UE is attempting to receive the signal from the other base station 508c. The first UE 504c may experience additional interference from the second UE 506c.

FIG. 5D shows the fourth example of full-duplex communication 530 in which a first base station 502d employs full-duplex communication with a first UE 504d, and transmits downlink communication to a second UE 506d. In this example, the first UE 504d is operating in a full-duplex mode, and the second UE 506d is operating in a half-duplex mode. The first base station 502d and the first UE 504d receive and transmit communication that overlaps in time and is in the same frequency band. The base station 502d and the first UE 504d may each experience self-interference, due to a transmitted signal from the corresponding device leaking to (e.g., being received by) a receiver at the same device. The base station 502d may further experience cross link interference due to a signal transmitted by the base station 508d. The second UE 506d may experience cross-link interference from the uplink transmission of the first UE 504b when receiving downlink communication from the base station 502d.

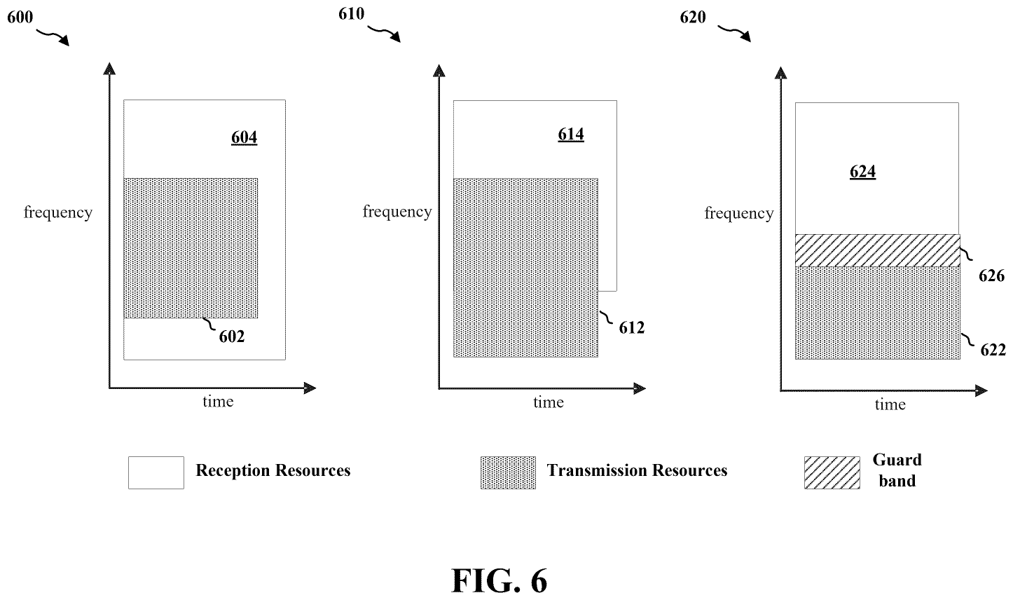

Full duplex communication may be in a same frequency band. The uplink and downlink communication may be in different frequency sub-bands, in the same frequency sub-band, or in partially overlapping frequency sub-bands. FIG. 6 illustrates a first example 600 and a second example 610 of in-band full-duplex (IBFD) resources and a third example 620 of SBFD resources. In IBFD, signals may be transmitted and received in overlapping times and overlapping in frequency. As shown in the first example 600, a time and a frequency allocation of transmission resources 602 may fully overlap with a time and a frequency allocation of reception resources 604. In the second example 610, a time and a frequency allocation of transmission resources 612 may partially overlap with a time and a frequency of allocation of reception resources 614.

IBFD is in contrast to sub-band FDD, where transmission and reception resources may overlap in time using different frequencies, as shown in 620. As shown in 620, the transmission resources 622 are separated from the reception resources 624 by a guard band 626. The guard band may be frequency resources, or a gap in frequency resources, provided between the transmission resources 622 and the reception resources 624. Separating the transmission frequency resources and the reception frequency resources with a guard band may help to reduce self-interference. Transmission resources and reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources 602, 612, and 622 may correspond to uplink resources, and the reception resources 604, 614, and 624 may correspond to downlink resources, in some aspects. Alternatively, if the full-duplex operation is for a base station or a device implementing base station functionality, the transmission resources 602, 612, and 622 may correspond to downlink resources, and the reception resources 604, 614, and 624 may correspond to uplink resources.

A time division duplex (TDD) configuration (e.g., which may be referred to as a TDD-UL-DL configuration) may indicate a pattern of time resources (e.g., one or more symbols or one or more slots) including downlink resources, uplink resources, or flexible resources. In some aspects, a slot format may be referred to as a “D+U” slot or an SBFD slot when the slot has a frequency band that is used for both uplink and downlink transmissions. The downlink and uplink transmissions may occur in overlapping frequency resources, such as shown in 604 and 606 (e.g., in-band full duplex resources) or may occur in adjacent or slightly separated frequency resources, such as shown in 620 (e.g., SBFD resources). In a particular D+U symbol, a half-duplex device may either transmit in the uplink band or receive in the downlink band. In a particular D+U symbol, a full-duplex device may transmit in the uplink band and receive in the downlink band, e.g., in the same symbol or in the same slot. A D+U slot may include downlink only symbols, uplink only symbols, and full-duplex symbols.

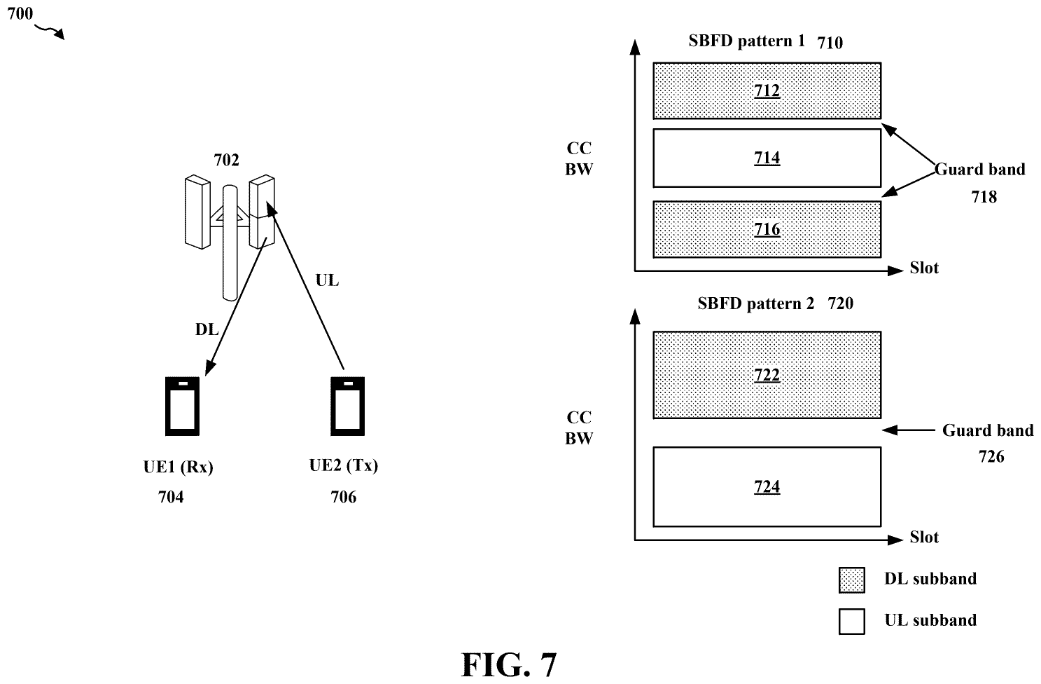

At the network side, SBFD operation allows the network (e.g., a base station) to simultaneously serve UEs on both DL and UL on corresponding sub-bands. FIG. 7 is a diagram 700 illustrating an example of the network SBFD operation. As shown in FIG. 7, the network (e.g., base station 702) may operate in the full duplex (FD) mode and simultaneously serve one UE (UE1 704) on an DL and another UE (UE2 706) on an UL. In SBFD operations, the DL and UL communication may occur simultaneously within the corresponding sub-bands of the same symbol or slot. For example, in FIG. 7, the first example SBFD pattern (SBFD pattern 1 710) may follow a D+U+D configuration, which includes a DL sub-band 712, an UL sub-band 714, and another DL sub-band 716. FIG. 7 illustrates an example in which a portion of an antenna panel at the base station 702 may transmit the downlink communication, and a portion of the antenna panel at the base station 702 may receive the uplink communication. The second example SBFD pattern (SBFD pattern 2 720) may utilize a D+U configuration, which includes a DL sub-band 722 and an UL sub-band 724. To minimize interference between DL and UL sub-bands, one or more guard bands (e.g., guard bands 718, 726) may be provided that include a number of resource blocks (RBs) between the DL and UL sub-bands.

SBFD operation allows simultaneous transmitting and receiving of downlink and uplink signals on a sub-band basis. The SBFD operation may increase the UL duty cycle, resulting in reduced latency. For example, SBFD operation allows for the transmission of the UL signal in the UL sub-band (e.g., 712 and 716) in DL slots or flexible slots. On the other hand, SBFD operation also allows the reception of DL signals in DL sub-band in UL slots. These adaptations help to reduce latency. Additionally, SBFD contributes to an improvement in UL coverage, e.g., by enabling UL transmissions at the same time as DL communication (e.g., simultaneous UL transmission via UL sub-band 724 and DL transmission via DL sub-band 722). Furthermore, SBFD operation enhances the system's capacity, resource utilization, and overall spectrum efficiency, and enables dynamic and flexible UL/DL resource adaptation according to UL and DL traffic, thereby optimizing the network's performance.

In some aspects, the resources, such as symbols or slots, may be configured as flexible or DL/‘D’ (e.g., in a TDD-UL-DL configuration such as TDD-UL-DL-ConfigCommon) for the SBFD operation. For SBFD operation in a symbol configured as flexible or D (e.g., in TDD-UL-DL-ConfigCommon), several resource and communication arrangements may be made to accommodate the SBFD operation for SBFD-aware UEs (i.e., UEs that are aware of the network's operation in the SBFD mode) which may be SBFD-capable or may not be SBFD-capable.

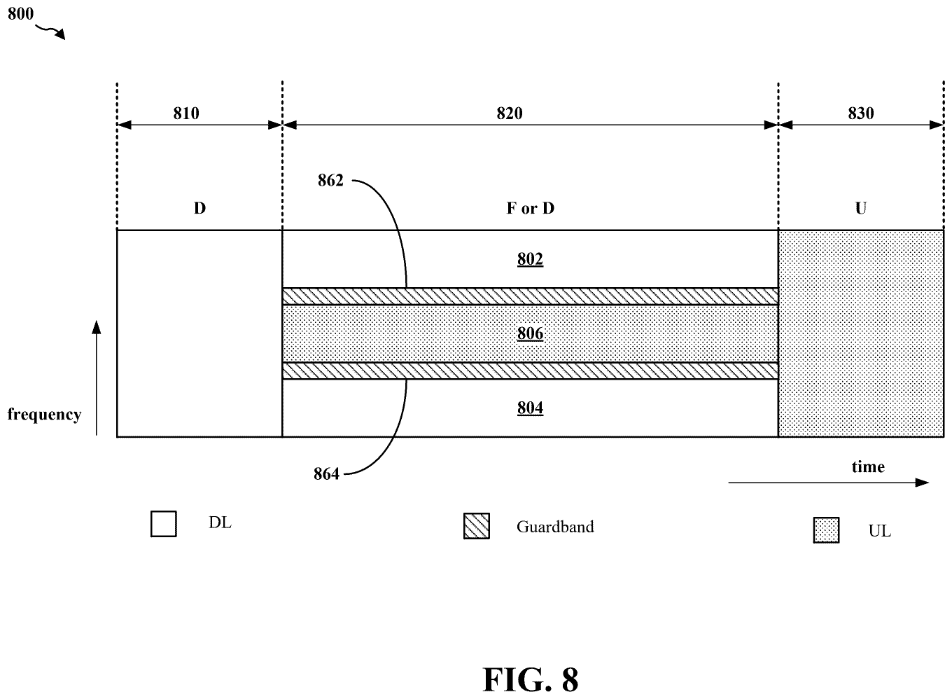

FIG. 8 is a diagram 800 illustrating example TDD resources including a time period 810 (e.g., one or more slots and/or symbols) for downlink, a time period 820 (e.g., one or more slots and/or symbols) for SBFD operation, and a time period 830 (e.g., one or more slots and/or symbols) for uplink in accordance with various aspects of the present disclosure. As shown in FIG. 8, in some examples, a time period (e.g., which may span one or more slots and/or symbols) may be configured as flexible or downlink (F or D) that may allow for UL transmissions within the UL sub-band (e.g., UL sub-band 806) in the slot and/or symbol, while UL transmissions outside the UL sub-band (e.g., outside the UL sub-band 806) are not allowed in the slot and/or symbol. The frequency locations of the DL sub-bands (e.g., DL sub-bands 802 and 804) may be known to the SBFD-aware UE, and the DL receptions within the DL sub-bands (e.g., DL sub-bands 802 and 804) are allowed in the slot and/or symbol.

In some examples, a slot and/or symbol configured as flexible may allow for UL transmissions within the UL sub-band (e.g., UL sub-band 806) in the symbol. In the symbol, the resource blocks (RBs) located outside the UL sub-band (e.g., outside the UL sub-band 806) may be utilized for either UL or DL transmissions, excluding any guard bands (e.g., guard bands 862 and 864) if used, from the network's perspective, and the direction of the transmission for all these RBs may be the same. In these examples, the frequency locations of the DL sub-bands (e.g., DL sub-bands 802 and 804) may be known to the SBFD-aware UE, and DL receptions within the DL sub-bands (e.g., DL sub-bands 802 and 804) are allowed in the symbol. In the examples shown in FIG. 8, UL transmissions by a UE may occur within the active UL bandwidth part (BWP), and DL transmissions by a base station may be within the active DL BWP in the symbol.

In some aspects, an SBFD-aware UE that has been configured with UL sub-band in an SBFD slot and/or symbol configured as DL in a TDD-UL-DL-ConfigCommon may be used for UL transmission within the UL sub-band (e.g., UL sub-band 806) in the SBFD symbol. In some aspects, UL transmissions may not be transmitted outside of the UL sub-band (e.g., outside the UL sub-band 806) within the SBFD symbol. The frequency locations of the DL sub-bands (e.g., DL sub-bands 802 and 804) may be known to the SBFD-aware UE (e.g., explicitly indicated to the SBFD-aware UE or implicitly derived by the SBFD-aware UE), and the DL transmissions may be transmitted within the DL sub-bands (DL sub-bands 802 and 804) in the symbol. In some examples, the UL transmissions may be within an active UL BWP, and the DL transmissions from the base station may be within active DL BWP in the slot and/or symbol.

In some aspects of wireless communication, a sub-band full-duplex mode of operation may be used in which a portion of a bandwidth in a DL (or flexible) slot or symbol may be used for UL (or vice versa). The ability to transmit UL transmissions during what would otherwise be a DL slot may reduce latency, improve UL coverage, enhance system capacity/resource utilization/spectrum efficiency, enable flexible and dynamic UL/DL resource adaption according to UL/DL traffic in a robust manner. The UL transmissions, in some aspects, may include random access (e.g., associated with a random access channel or RACH) messages.

A UE may use a random access procedure in order to communicate with a base station. For example, the UE may use the random access procedure to request an RRC connection, to re-establish an RRC connection, resume an RRC connection, etc. A UE may use a random access procedure in order to communicate with a base station. For example, the UE may use the random access procedure to request an RRC connection, to re-establish an RRC connection, resume an RRC connection, etc. Random Access Procedures may include two different random access procedures, e.g., The UE may use Contention Based Random Access (CBRA) may be performed when a UE is not synchronized with a base station, and the CFRA may be applied, e.g., when the UE was previously synchronized to a base station. Both the procedures include transmission of a random access preamble from the UE to the base station. In CBRA, a UE may randomly select a random access preamble sequence, e.g., from a set of preamble sequences. As the UE randomly selects the preamble sequence, the base station may receive another preamble from a different UE at the same time. Thus, CBRA provides for the base station to resolve such contention among multiple UEs. In CFRA, the network may allocate a preamble sequence to the UE rather than the UE randomly selecting a preamble sequence. This may help to avoid potential collisions with a preamble from another UE using the same sequence. Thus, CFRA is referred to as “contention free” random access.

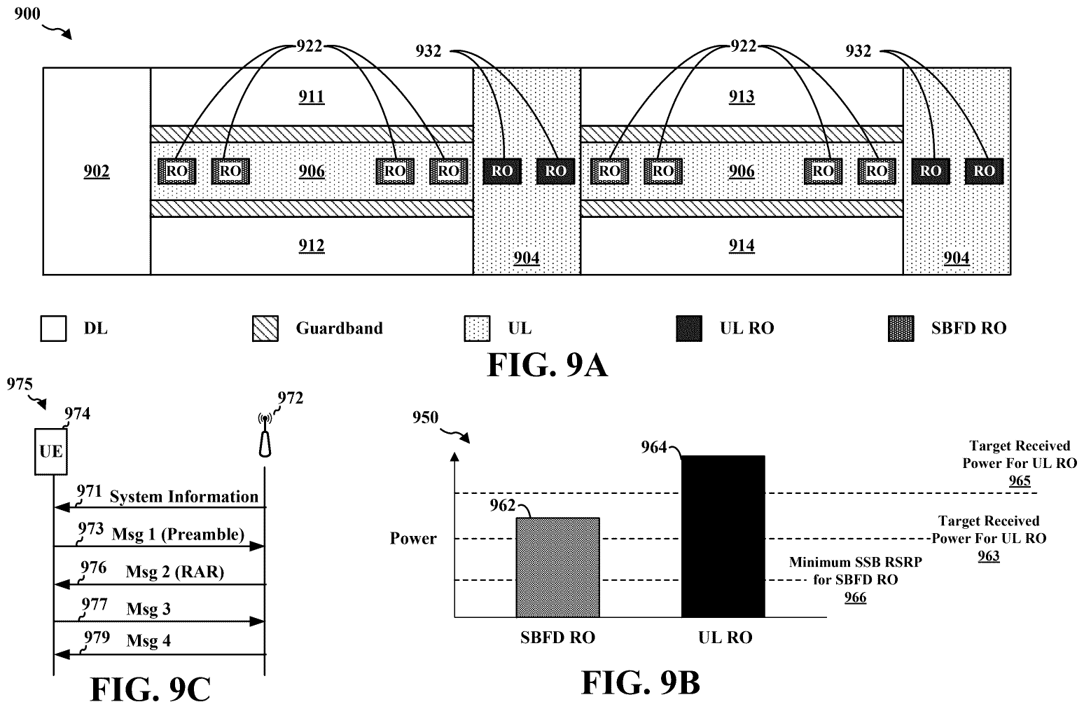

FIG. 9C illustrates example aspects of a random access procedure 975 between a UE 974 and a base station 972. The UE 974 may initiate the random access message exchange by sending, to the base station 972, a first random access message 973 (e.g., Msg 1) including a preamble in a random access occasion (RO). Prior to sending the first random access message 973, the UE may obtain random access parameters, e.g., including preamble format parameters, time and frequency resources, parameters for determining root sequences and/or cyclic shifts for a random access preamble, etc., e.g., in system information 971 from the base station 972. The preamble may be transmitted with an identifier, such as a Random Access RNTI (RA-RNTI). The UE 974 may randomly select a random access preamble sequence, e.g., from a set of preamble sequences. If the UE 974 randomly selects the preamble sequence, the base station 972 may receive another preamble from a different UE at the same time. In some examples, a preamble sequence may be assigned to the UE 974.

The base station responds to the first random access message 973 by sending a second random access message 976 (e.g. Msg 2) using PDSCH and including a random access response (RAR). The RAR may include, e.g., an identifier of the random access preamble sent by the UE, a time advance (TA), an uplink grant for the UE to transmit data, cell radio network temporary identifier (C-RNTI) or other identifier, and/or a back-off indicator. Upon receiving the RAR (e.g., in the second random access message 976), the UE 974 may transmit a third random access message 977 (e.g., Msg 3) to the base station 972, e.g., using PUSCH, that may include an RRC connection request, an RRC connection re-establishment request, or an RRC connection resume request, depending on the trigger for the initiating the random access procedure. The base station 972 may then complete the random access procedure by sending a fourth random access message 979 (e.g., Msg 4) to the UE 974, e.g., using PDCCH for scheduling and PDSCH for the message. The fourth random access message 979 may include a random access response message that includes timing advancement information, contention resolution information, and/or RRC connection setup information. The UE 974 may monitor for PDCCH, e.g., with the C-RNTI. If the PDCCH is successfully decoded, the UE 974 may also decode PDSCH. The UE 974 may send HARQ feedback for any data carried in the fourth random access message. If two UEs sent a same preamble at 703, both UEs may receive the RAR leading both UEs to send a third random access message 977. The base station 972 may resolve such a collision by being able to decode the third random access message from only one of the UEs and responding with a fourth random access message to that UE. The other UE, which did not receive the fourth random access message 979, may determine that random access did not succeed and may re-attempt random access. Thus, the fourth message may be referred to as a contention resolution message. The fourth random access message 979 may complete the random access procedure. Thus, the UE 974 may then transmit uplink communication and/or receive downlink communication with the base station 972 based on the RAR (e.g., included in the second random access message 976) and the fourth random access message 979.

In order to reduce latency or control signaling overhead, a single round trip cycle between the UE and the base station may be achieved in a 2-step RACH process. Aspects of Msg 1 and Msg 3 may be combined in a single message, e.g., which may be referred to as Msg A. The Msg A may include a random access preamble, and may also include a PUSCH transmission, e.g., such as data. The MsgA preambles may be separate from the four step preambles, yet may be transmitted in the same ROs as the preambles of the four step RACH procedure or may be transmitted in separate ROs. The PUSCH transmissions may be transmitted in PUSCH occasions (POs) that may span multiple symbols and PRBs. After the UE transmits the Msg A, the UE may wait for a response from the base station. Additionally, aspects of the Msg 2 and Msg 4 may be combined into a single message, which may be referred to as Msg B.

If random access is allowed in SBFD slots and/or symbols for SBFD-aware UEs (e.g., UEs that are aware of the network's operation in the SBFD mode), it may potentially reduce the random access latency, reduce the physical RACH (PRACH) collision probability and/or improve the coverage of PRACH and Msg3. However, RACH (e.g., PRACH and Msg3) transmissions in the UL sub-band in SBFD symbols may cause UE-to-UE cross link interference (CLI).

Various aspects relate generally to limiting UE-to-UE CLI associated with the use of SBFD RACH occasions (ROs). Some aspects more specifically relate to different options to specify RACH occasion behavior for connected UEs within SBFD symbols. For example, some options may be summarized as allowing connected UEs to use SBFD ROs, using controlled PRACH (e.g., PDCCH ordered PRACH), specifying behaviors of non-SBFD-capable UEs, limiting PRACH transmit power, and limiting power by applying a minimum RSRP (DL) for a DL transmission before an SBFD-capable UE may use SBFD ROs. In some examples, a wireless device or UE configured to receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a random access occasion (RO) in an uplink sub-band of an SBFD time period. In some examples, a network device or base station configured to provide time and frequency information for SBFD resources and provide at least one random access configuration for random access in the SBFD resources, where the random access configuration is associated with one or more conditions of a random access event trigger condition, a power condition, or a conflicting signal condition.

FIG. 9A is a diagram 900 illustrating a set of RACH occasions (e.g., ROs) that may be configured within UL resources in accordance with some aspects of the disclosure. FIG. 9A illustrates a set of resources including a set of ROs (e.g., including the SBFD ROs 922 (ROs within an SBFD time resource) and the UL ROs 932 (ROs within an UL time period)). For example, the ROs may occur within UL resources, e.g., UL sub-band 906 of an SBFD slot or symbol or UL slot 904 or symbol. For example, in some aspects, the ROs may be configured in a common RACH configuration for SBFD-aware UEs and non-SBFD-aware UEs. Additional resources may be associated with DL transmissions or UL resources. For example, the set of resources may include a first DL period 902 (e.g., DL slot(s) or symbol(s)). Additional DL resources may be provided in a D or F period (of one or more slots or symbols), such as any of the sub-band 911, the sub-band 912, the sub-band 913, and/or the sub-band 914, as illustrated in FIG. 9A.

The set of ROs, and more specifically the SBFD ROs 922, in some aspects, may be used for transmitting a RACH message associated with one or more of initial access (e.g., from a UE in an RRC IDLE or RRC INACTIVE mode) or other RACH types and/or operations (e.g., RACH operations associated with a UE in an RRC connected mode). In some aspects, the use of the SBFD ROs 922 may be conditional for use by UEs in a connected mode, and the ROs 932 in non-SBFD time periods may be used for any RACH messages without restriction. As an example, UEs in an RRC connected state may transmit a random access message in the ROs 922, and UEs in an RRC inactive or RRC idle state may not. UEs in an RRC connected state and UEs in an RRC idle or RRC inactive state may transmit a random access message in the ROs 932.

For UEs in a connected mode, the use of the SBFD ROs 922 may be further conditional based on a type of random access. Table 2 includes various examples of types of random access. In some aspects, the use of SBFD ROs 922 may be conditional based on the random access being one or more of the types described in table 2.

TABLE 2

| Random Access Trigger Events | CBRA | CFRA |
|---|---|---|
| Initial access from RRC_Idle | 0 | — |
| RRC connection re-establishment procedure | 0 | — |
| Handover | 0 | 0 |
| Beam failure recovery | 0 | 0 |
| RRC connection resume procedure from | 0 | — |
| RRC_inactive | | |
| DL out of sync | 0 | 0 |
| UL out of sync | 0 | — |
| Explicit request by RRC upon synchronous | 0 | 0 |
| reconfiguration | | |
| To establish time alignment for a secondary TAG | 0 | 0 |

As an example, the use of the SBFD ROs 922 may be used by RRC connected UEs for PDCCH ordered PRACH transmissions (e.g., RACH messages). In such aspects, the UE may not be expected to use ROs in SBFD resources (e.g., slots or symbols) without receiving an indication from a network device (e.g., PDCCH ordered RACH). In some aspects, the PDCCH ordered RACH may be limited to contention free random access (CFRA) to better allow the network device (e.g., the network) to control the CLI introduced by the RACH message to other UEs receiving DL transmissions. In this example, an RRC connected UE may transmit a random access message for CFRA in the ROs 922 and may not transmit a random access message for CBRA.

The SBFD ROs, in some aspects, may also be used by the connected UEs for contention based random access (CBRA). The use of the SBFD ROs for both CFRA and CBRA may reduce the network control of the (inter-UE) CLI associated with the RACH messages while increasing the number of ROs available for CBRA. Accordingly, the network may dynamically determine whether to configure SBFD ROs for CFRA only or for both CFRA and CBRA based on conditions known to the base station (e.g., a number of connected UEs, a current traffic load, available bandwidth, or other considerations).

In some aspects, the use of the SBFD ROs 922 may be limited and/or restricted to CFRA based PRACH transmissions with a reserved preamble dedicated for improved inter-UE CLI control. For example, one or more preambles (e.g., a subset of the preambles) may be associated with random access in full-duplex resources or SBFD resources, or for circumstances that may involve inter-UE CLI. The set of preambles may be defined, e.g., in a wireless standard, or may be indicated to the UE in a configuration from the base station. In some aspects, the preambles for random access in SBFD resources may be indicated together in a RACH configuration for non-SBFD resources. In other examples, a separate RACH configuration may be provided for random access in SBFD resources. In some aspects, a RO may be associated with one or more preambles. A RO in a SBFD time period may be associated with a preamble that is dedicated for SBFD RACH. The CFRA based PRACH transmissions, in some aspects, may be associated with PDCCH ordered CFRA (e.g., network initiated CFRA) but not UE-initiated CFRA. For example, the use of the SBFD ROs 922 may be conditional for PDCCH ordered CFRA. In some aspects, the SBFD ROs 922 may be used for CFRA based PRACH transmissions for either PDCCH ordered CFRA (e.g., network initiated CFRA) or UE-initiated CFRA. In such aspects, the UE may not be expected to use CBRA based ROs in SBFD slots and/or symbols or to use SBFD ROs for CBRA. The SBFD-aware UEs, in some aspects, may receive an indication of the SBFD ROs and/or the restriction on the SBFD ROs. For example, an SBFD aware UE is a UE that supports a knowledge of resources that may be used by the base station for full-duplex (e.g., SBFD) communication, e.g., even though the UE may operate in a half-duplex manner with the base station. For example, the SBFD aware UE may be capable of interpreting information indicated by the network to inform the UE of the resources that may be used by the base station for SBFD communication. Additionally, non-SBFD-aware UEs may identify an SBFD RO included in, or overlapping with, a D slot and/or symbol as invalid. In some aspects, a non-SBFD-aware UE may, for SBFD ROs included in, or overlapping with, an F slot and/or symbol, be provided with an indication of the restriction to CFRA transmissions (e.g., either network initiated CFRA or network initiated CFRA and UE initiated CFRA). For example, the non-SBFD-aware UE may receive a dedicated RACH configuration including a mask (e.g., a bitmask) identifying the SBFD ROs restricted to CFRA and whether they are restricted to network initiated (e.g., PDCCH ordered) CFRA or to network initiated CFRA and UE initiated CFRA.

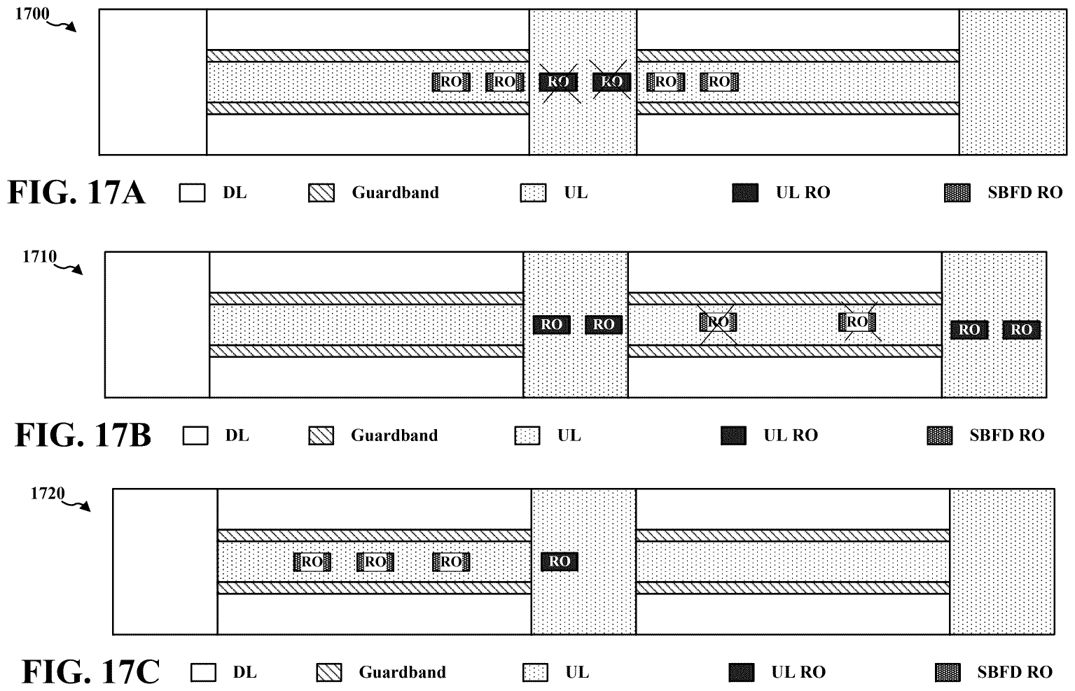

An SBFD-aware UE, in some aspects, may be configured to use a repetition determination rule without repetition consideration of cross SBFD ROs and UL ROs. For example, repetition 4 of PRACH, in some aspects, may be configured for 4 repetitions of SBFD ROs that occur within the UL sub-band of SBFD slots (e.g., in an UL sub-band 906) or 4 repetitions in UL ROs that occur within UL slots (e.g., UL slot 904) (e.g., but not for repetitions in ROs across different types of slots). FIG. 17A illustrates an example 1700 in which the UE may transmit in SBFD ROs and skip the UL ROs to transmit the 4 repetitions. FIG. 17B illustrates an example 1710 in which the UE may transmit in the UL ROs and skip the SBFD ROs in order to transmit the 4 repetitions. Alternatively, an SBFD-aware UE, in some aspects may be configured to use a repetition determination rule with repetition consideration of cross SBFD ROs and UL ROs. FIG. 17C illustrates an example 1720 in which the UE may transmit the 4 repetitions regardless of whether the ROs are SBFD or UL. As another example, repetition 4 of PRACH, in some aspects, may include 2 repetitions of SBFD ROs in the UL sub-band of SBFD slots (e.g., in an UL sub-band 906) and 2 repetitions of UL ROs in UL slots (e.g., UL slot 904).

FIG. 9B is a diagram 950 illustrating power-related thresholds that may be applied in accordance with some aspects of the disclosure. In some aspects, the inter-UE CLI may be reduced by restricting a transmission power associated with SBFD ROs (e.g., a maximum_PRACH_TxPower set by the network) and/or a target PRACH received power (e.g., a preambleReceivedTargetPower) compared to transmissions in UL ROs. For example, as illustrated in diagram 950 a first maximum transmission power 962 may be associated with RACH transmissions during an SBFD RO while a second, higher, maximum transmission power 964 may be associated with RACH transmissions during an UL RO. In some examples, instead of specifying or indicating a maximum transmission power, the network may specify or indicate a target receive power at the network device, where the target receive power is lower for the SBFD RO than for the UL RO (e.g., target receive power 963 for the SBFD RO transmission may be less than the target receive power 965 for the UL RO transmission). The power restriction, in some aspects, may be applied in addition, or as an alternative, to the restrictions described above.

In some aspects, the use of SBFD ROs may be restricted to UEs measuring a signal from the network (e.g., an SSB) with a reference signal received power (RSRP) greater than a threshold RSRP value 966. The restriction to the UEs measuring the signal with an RSRP greater than the threshold RSRP value, in some aspects, serves to reduce the transmit power associated with the SBFD ROs as the threshold may be set to limit the use of the SBFD ROs to UEs in (close) proximity to a network device (e.g., a base station) that are already operating with a reduced transmission power based on the proximity to the network device. For example, the RSRP threshold may be set to limit the use of the SBFD ROs to “cell-center” UEs (e.g., UEs within a certain radius of a serving network device and/or base station) that are not likely to generate inter-UE CLI as the transmit power from the cell-center UE may be less than a transmit power used by UEs farther from the network device. Additionally, the DL signal may be stronger at other cell-center UEs that might otherwise experience inter-UE CLI from the transmitting UE.

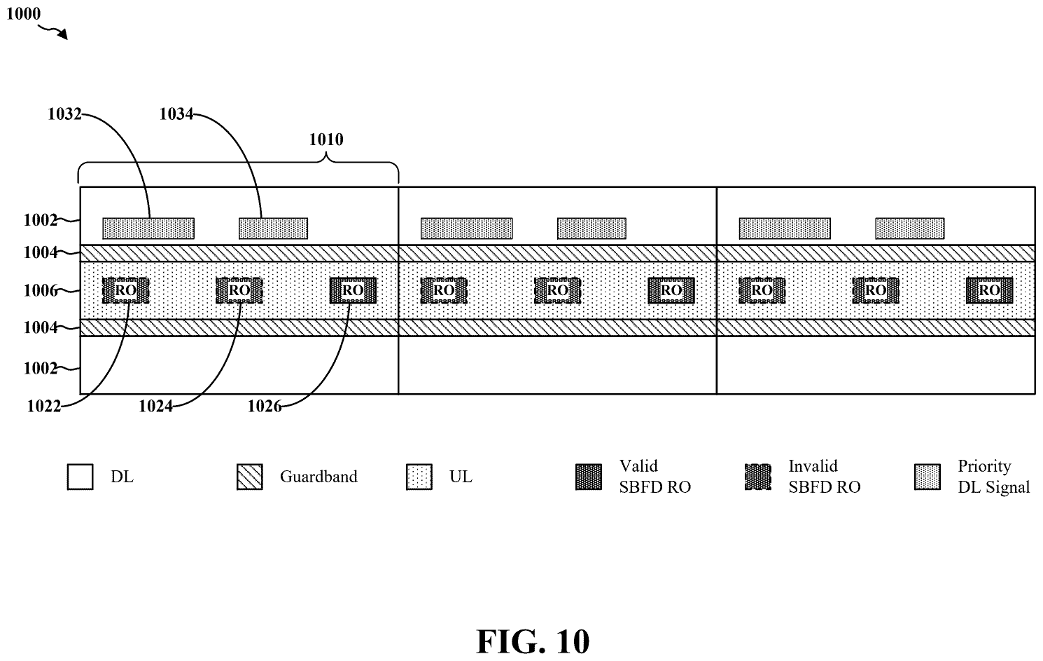

FIG. 10 is a diagram 1000 illustrating that some SBFD ROs may be invalid when overlapping fully, or partially, with one or more DL transmissions in accordance with some aspects of the disclosure. Diagram 1000 illustrates a set of SBFD slots (e.g., SBFD slot 1010) including SBFD ROs (e.g., SBFD RO 1022, SBFD RO 1024, and SBFD RO 1026). The set of SBFD slots, in some aspects, may also include a set of high priority DL signals (e.g., DL signal 1032 and DL signal 1034) in a DL sub-band 1002. In some aspects, the high priority DL signals may be DL signals with no retransmissions such as an SSB (e.g., for an idle UE or a connected UE), periodic CSI-RS (e.g., for an idle UE or for a connected UE to update a time or frequency (TF) offset), PDCCH (for idle UE monitoring broadcasted PDSCH reception or connected UE), broadcasted PDSCH (paging, remaining system information (RMSI), other system information (OSI), etc.) to protect idle UEs. In some aspects, the DL sub-band 1002 and an UL sub-band 1006 may be separated by a guard band 1004 (which may have a size of zero or more subcarriers).

As illustrated, the SBFD RO 1022 may be invalid (e.g., not used, or not expected to be used, for RACH transmissions) because it fully overlaps, or falls within, a time associated with a priority DL signal 1032. Similarly, the SBFD RO 1024 may be invalid (e.g., not used, or not expected to be used, for RACH transmissions) because it at least partially overlaps a time associated with a priority DL signal 1034. Finally, the SBFD RO 1026 may be valid, at least in part, based on not overlapping with a high priority DL signal.

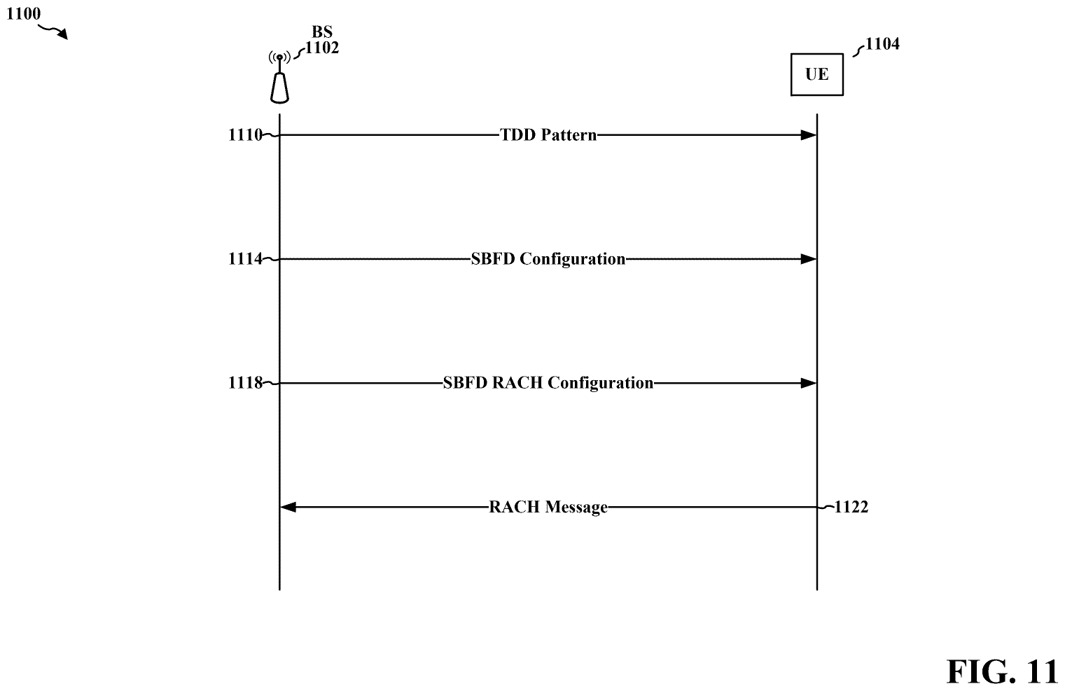

FIG. 11 is a call flow diagram 1100 illustrating a method of using SBFD ROs in accordance with some aspects of the disclosure. The method is illustrated in relation to a base station 1102 (e.g., as an example of a network device or network node that may include one or more components of a disaggregated base station) in communication with a UE 1104 (e.g., as an example of a wireless device). The functions ascribed to the base station 1102, in some aspects, may be performed by one or more components of a network entity, a network node, or a network device (a single network entity/node/device or a disaggregated network entity/node/device as described above in relation to FIG. 1). Similarly, the functions ascribed to the UE 1104, in some aspects, may be performed by one or more components of a wireless device supporting communication with a network entity/node/device. Accordingly, references to “transmitting” in the description below may be understood to refer to a first component of the base station 1102 (or the UE 1104) outputting (or providing) an indication of the content of the transmission to be transmitted by a different component of the base station 1102 (or the UE 1104). Similarly, references to “receiving” in the description below may be understood to refer to a first component of the base station 1102 (or the UE 1104) receiving a transmitted signal and outputting (or providing) the received signal (or information based on the received signal) to a different component of the base station 1102 (or the UE 1104).

The base station 1102 may transmit, and a UE 1104 may receive, a TDD pattern indication 1110. The TDD pattern indication 1110, in some aspects, may indicate a pattern of D, U, and F slots, for example as described in relation to FIGS. 8 and 9A. The base station 1102 may transmit, and the UE 1104 may receive, SBFD configuration 1114. The SBFD configuration 1114, in some aspects, may configure at least an UL sub-band and may further include an indication of one or more guard bands and one or more DL sub-bands.

The base station 1102 may transmit, and the UE 1104 may receive, SBFD RACH configuration messages 1118. The SBFD RACH configuration messages 1118, in some aspects, may include multiple transmissions. For example, the SBFD RACH configuration messages 1118, in some aspects, may include a common RACH configuration and one or more dedicated RACH configurations. In some aspects, the SBFD RACH configuration messages 1118 may include time and frequency information for SBFD RACH resources. The SBFD RACH configuration messages 1118, in some aspects, may indicate, or include, at least one random access configuration for random access in the SBFD resources.

In some aspects, the random access configuration may include and/or indicate one or more conditions such as a random access event trigger condition, a power condition, a UE type condition, or a conflicting signal condition. The random access event trigger condition, in some aspects, may be for random access in an RRC connected mode. In some aspects, the random access event trigger condition may be for a PDCCH scheduled random access transmission. The random access event trigger condition, in some aspects, may be for the PDCCH scheduled random access transmission for CFRA. In some aspects, the random access event trigger condition is for the PDCCH scheduled random access transmission for CFRA or CBRA. The random access event trigger condition, in some aspects, may be for a CFRA transmission with a reserved preamble associated with the random access in the SBFD resources and, in some aspects, may further be based on a PDCCH scheduled random access transmission. In some aspects, the random access event trigger condition may be based on a UE initiated random access transmission.

In some aspects, the power condition may be associated with one or more of a maximum transmission power of RACH transmissions, a reduced target receive power of a RACH transmission. The UE type condition, in some aspects, may be associated with cell-center UEs that are expected to measure an RSRP of a received DL signal (e.g., a received SSB) with at least a threshold power. Accordingly, the UE type condition may be associated with a measured RSPR of a signal associated with an RO being above an RSRP threshold for the random access in the SBFD resources. In some aspects, the conflicting signal condition may be based on, or associated with, the RO occurring in a symbol (or set of symbols) that does not include one or more of a SSB, a periodic CSI-RS, a PDCCH transmission, or a broadcast PDSCH transmission. The conflicting signal condition, in some aspects, may be based on the RO occurring in a symbol that does not include one or more of (1) the SSB when the UE is in an RRC idle state or an RRC connected state, (2) the periodic CSI-RS when the UE is in the RRC idle state or the RRC connected state, (3) the PDCCH transmission for when the UE is in the RRC idle state while monitoring for the broadcast PDSCH transmission or when the UE is in the RRC connected state, or (4) the broadcast PDSCH transmission that includes one or more of paging information, RMSI, or OSI.

In some aspects, the at least one random access configuration may include a repetition rule indicating (1) that repetitions of a first RACH message transmitted via either the SBFD resources or via non-SBFD uplink resources are allowed via the SBFD resources or the non-SBFD uplink resources (e.g., as in FIG. 17C), or (2) that repetitions of the first RACH message transmitted via the SBFD resources are not allowed via the non-SBFD uplink resources (e.g., as in FIG. 17A) and that repetitions of the first RACH message transmitted via the non-SBFD uplink resources are not allowed via the SBFD resources (e.g., as in FIG. 17B).

Based on the SBFD configuration 1114 and the SBFD RACH configuration messages 1118, the UE 1104 may transmit, and the base station 1102 may receive, a RACH message 1122. In some aspects, the RACH message 1122 may be a random access message in an RO in an uplink sub-band of an SBFD time period. The RACH message 1122, in some aspects, may be transmitted based on meeting one or more of the conditions included in the SBFD RACH configuration messages 1118 (e.g., a random access event trigger condition, a power condition, a UE type condition, or a conflicting signal condition). In some aspects, transmitting the RACH message 1122 may be based on the power condition and may include transmitting the RACH message 1122 in the RO in the uplink sub-band with a transmission power that is below a power threshold (e.g., the first maximum transmission power 962) for the random access in the SBFD resources. The power threshold, in some aspects, may be a maximum PRACH transmission power or may be based on, or associated with, a (reduced) target PRACH receive power. In some aspects, transmitting the RACH message 1122 may be based on the UE type condition and may include transmitting the RACH message 1122 in the RO in the uplink sub-band based on a measured RSRP of a signal associated with the RO being above an RSRP threshold for the random access in the SBFD resources. Transmitting the RACH message 1122, in some aspects, may be based on the conflicting signal condition and may include transmitting the RACH message 1122 in uplink sub-band the RO that does not overlap in time with a downlink signal having a higher priority than the RACH message 1122. As described above, the conflicting signal condition may be based on the RO occurring in a symbol that does not include one or more of a SSB, a periodic CSI-RS, a PDCCH transmission, or a broadcast PDSCH transmission.

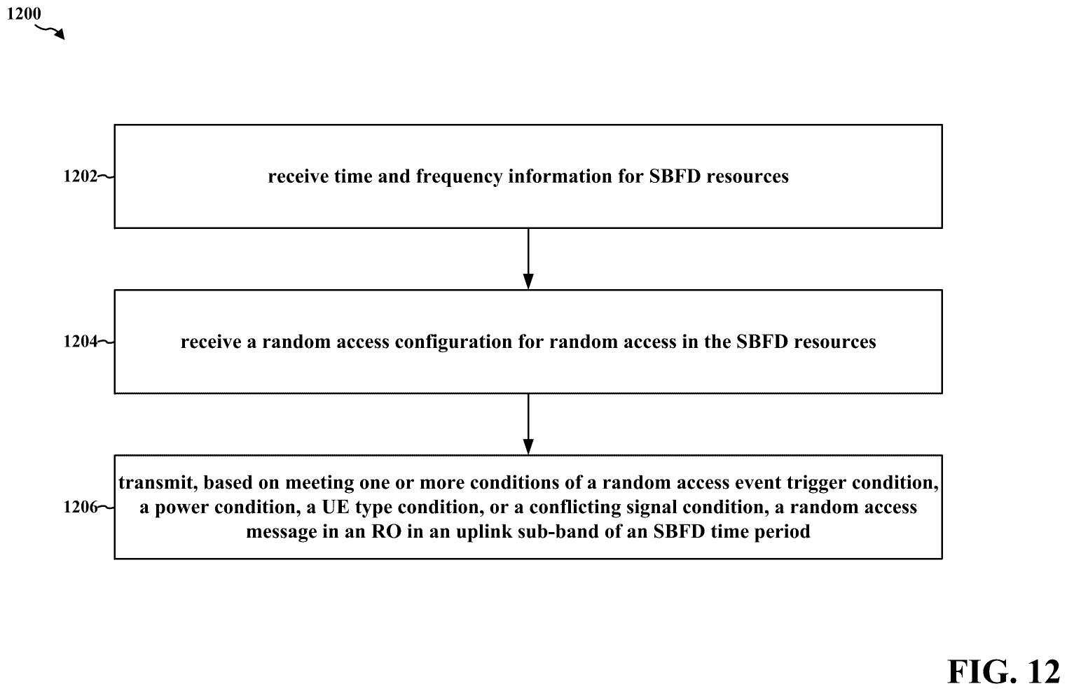

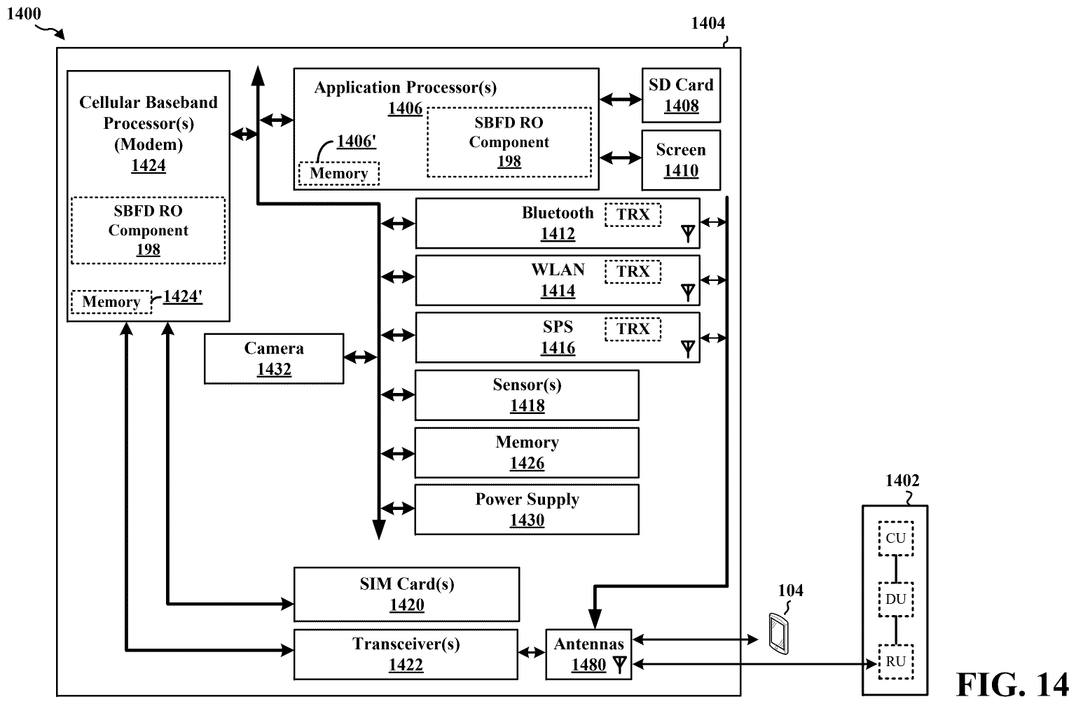

FIG. 12 is a flowchart 1200 of a method of wireless communication. The method may be performed by a UE (e.g., the UE 104, 1104; the apparatus 1404). In some aspects, the UE may receive an indication of a TDD pattern of resources. At 1202, the UE may receive time and frequency information for SBFD resources. For example, 1202 may be performed by application processor(s) 1406, cellular baseband processor(s) 1424, transceiver(s) 1422, antenna(s) 1480, and/or SBFD RO component 198 of FIG. 14. In some aspects, the SBFD resources may be for full-duplex operation of a network node, and the SBFD time period may include one or more symbols or one or more slots. For example, referring to FIG. 11, the UE 1104 may receive SBFD configuration 1114.

At 1204, the UE may receive at least one random access configuration for random access in the SBFD resources. For example, 1204 may be performed by application processor(s) 1406, cellular baseband processor(s) 1424, transceiver(s) 1422, antenna(s) 1480, and/or SBFD RO component 198 of FIG. 14. The random access configuration, in some aspects, may include multiple transmissions. For example, the random access configuration, in some aspects, may include a common RACH configuration and one or more dedicated RACH configurations. In some aspects, the random access configuration may include time and frequency information for SBFD RACH resources. The random access configuration, in some aspects, may indicate, or include, at least one random access configuration for random access in the SBFD resources.

In some aspects, the random access configuration may include and/or indicate one or more conditions such as a random access event trigger condition, a power condition, a UE type condition, or a conflicting signal condition. The random access event trigger condition, in some aspects, may be for random access in an RRC connected mode. In some aspects, the random access event trigger condition may be for a PDCCH scheduled random access transmission. The random access event trigger condition, in some aspects, may be for the PDCCH scheduled random access transmission for CFRA. In some aspects, the random access event trigger condition is for the PDCCH scheduled random access transmission for CFRA or CBRA. The random access event trigger condition, in some aspects, may be for a CFRA transmission with a reserved preamble associated with the random access in the SBFD resources and, in some aspects, may further be based on a PDCCH scheduled random access transmission. In some aspects, the random access event trigger condition may be based on a UE initiated random access transmission.

In some aspects, the power condition may be associated with one or more of a maximum transmission power of RACH transmissions, a reduced target receive power of a RACH transmission. The UE type condition, in some aspects, may be associated with cell-center UEs that are expected to measure an RSRP of a received DL signal (e.g., a received SSB) with at least a threshold power. Accordingly, the UE type condition may be associated with a measured RSPR of a signal associated with an RO being above an RSRP threshold for the random access in the SBFD resources. In some aspects, the conflicting signal condition may be based on, or associated with, the RO occurring in a symbol (or set of symbols) that does not include one or more of a SSB, a periodic CSI-RS, a PDCCH transmission, or a broadcast PDSCH transmission. The conflicting signal condition, in some aspects, may be based on the RO occurring in a symbol that does not include one or more of (1) the SSB when the UE is in an RRC idle state or an RRC connected state, (2) the periodic CSI-RS when the UE is in the RRC idle state or the RRC connected state, (3) the PDCCH transmission for when the UE is in the RRC idle state while monitoring for the broadcast PDSCH transmission or when the UE is in the RRC connected state, or (4) the broadcast PDSCH transmission that includes one or more of paging information, RMSI, or OSI.

In some aspects, the at least one random access configuration may include a repetition rule indicating (1) that repetitions of a first RACH message transmitted via either the SBFD resources or via non-SBFD uplink resources are allowed via the SBFD resources or the non-SBFD uplink resources (e.g., as in FIG. 17C), or (2) that repetitions of the first RACH message transmitted via the SBFD resources are not allowed via the non-SBFD uplink resources (e.g., as in FIG. 17A) and that repetitions of the first RACH message transmitted via the non-SBFD uplink resources are not allowed via the SBFD resources (e.g., as in FIG. 17B). For example, referring to FIG. 11, the UE 1104 may receive SBFD RACH configuration messages 1118.

At 1206, the UE may transmit, based on meeting one or more conditions of a random access event trigger condition, a power condition, a UE type condition, or a conflicting signal condition, a random access message in a RO in an uplink sub-band of an SBFD time period. For example, 1206 may be performed by application processor(s) 1406, cellular baseband processor(s) 1424, transceiver(s) 1422, antenna(s) 1480, and/or SBFD RO component 198 of FIG. 14. In some aspects, the random access message may be a random access message in an RO in an uplink sub-band of an SBFD time period. The random access message, in some aspects, may be transmitted based on meeting one or more of the conditions included in the random access configuration received at 1204 (e.g., a random access event trigger condition, a power condition, a UE type condition, or a conflicting signal condition). In some aspects, transmitting the random access message may be based on the power condition and may include transmitting the random access message in the RO in the uplink sub-band with a transmission power that is below a power threshold (e.g., the first maximum transmission power 962) for the random access in the SBFD resources. The power threshold, in some aspects, may be a maximum PRACH transmission power (e.g., the first maximum transmission power 962) or may be based on, or associated with, a target PRACH receive power (e.g., target received power 963 for the SBFD RO transmission). In some aspects, transmitting the random access message may be based on the UE type condition and may include transmitting the RACH message 1122 in the RO in the uplink sub-band based on a measured RSRP of a signal associated with the RO being above an RSRP threshold for the random access in the SBFD resources. Transmitting the random access message, in some aspects, may be based on the conflicting signal condition and may include transmitting the random access message in uplink sub-band the RO that does not overlap in time with a downlink signal having a higher priority than the random access message. As described above, the conflicting signal condition may be based on the RO occurring in a symbol that does not include one or more of a SSB, a periodic CSI-RS, a PDCCH transmission, or a broadcast PDSCH transmission. For example, referring to FIG. 11, the UE 1104 may transmit RACH message 1122.

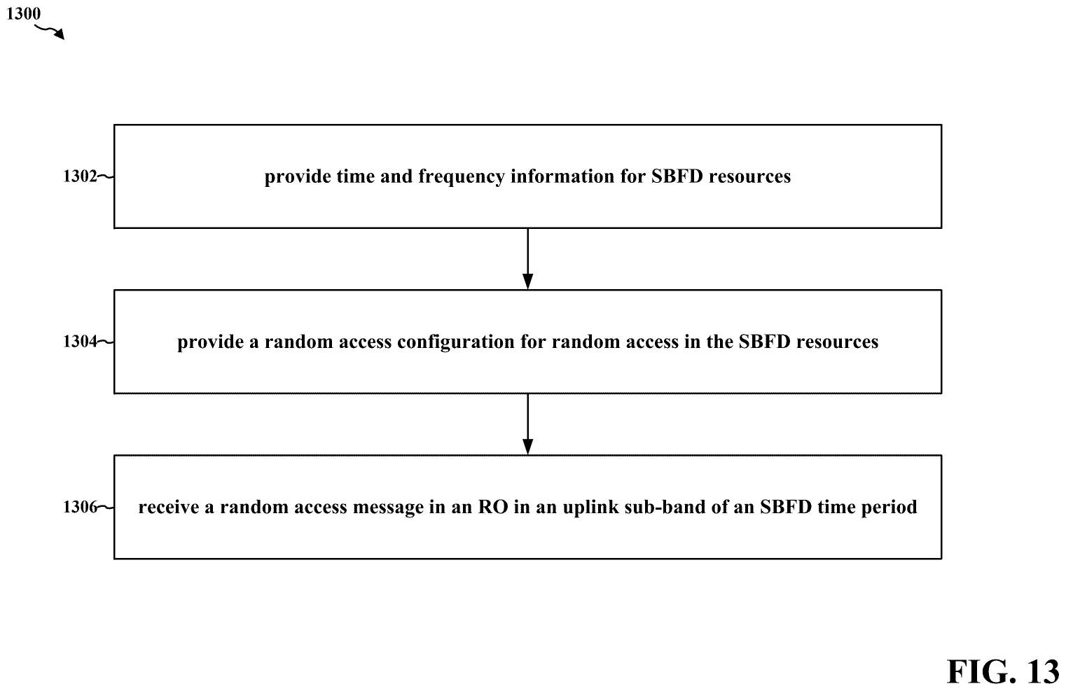

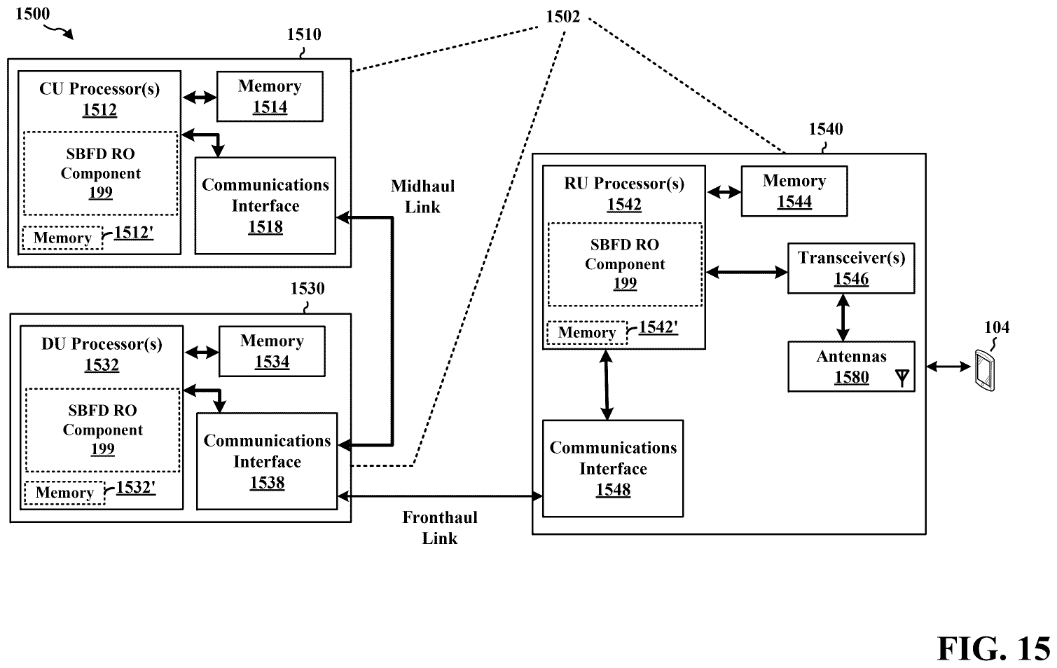

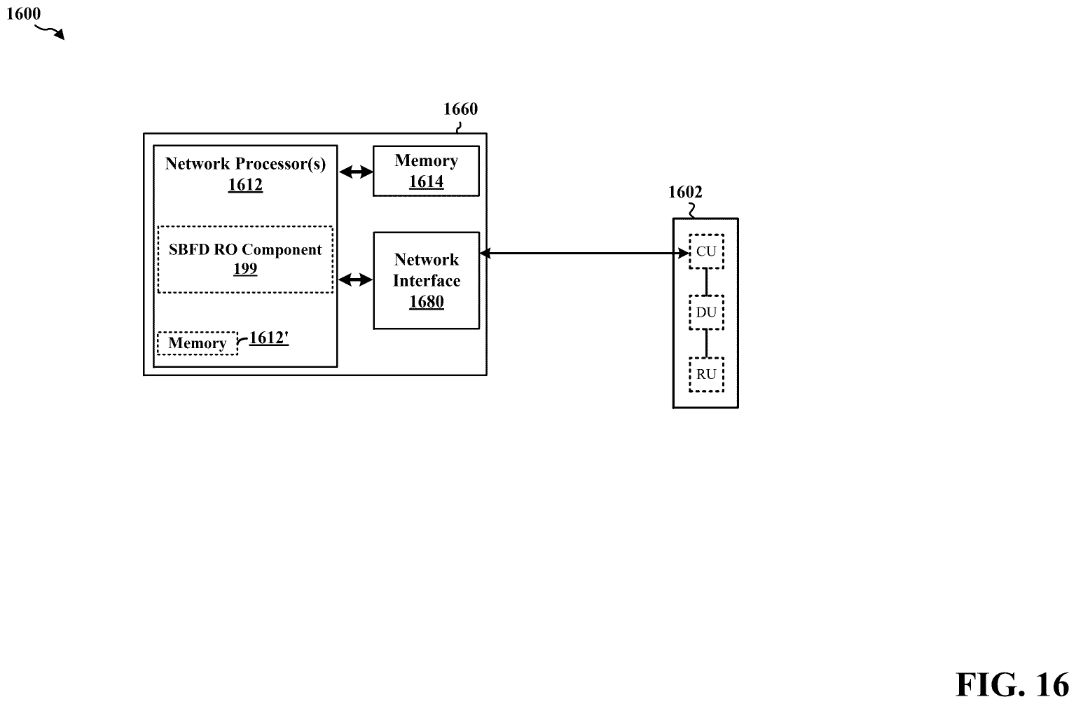

FIG. 13 is a flowchart 1300 of a method of wireless communication. The method may be performed by a base station (e.g., the base station 102, 1102; the network entity 1402, 1502, 1660). In some aspects, the base station may provide an indication of a TDD pattern of resources. At 1302, the base station may provide time and frequency information for SBFD resources. For example, 1302 may be performed by CU processor(s) 1512, DU processor(s) 1532, RU processor(s) 1542, transceiver(s) 1546, antenna(s) 1580, network processor 1612, network interface 1680, and/or SBFD RO component 199 of FIGS. 15 and 16. In some aspects, the SBFD resources may be for full-duplex operation of a network node, and the SBFD time period may include one or more symbols or one or more slots. For example, referring to FIG. 11, the base station 1102 may transmit SBFD configuration 1114.

At 1304, the base station may provide at least one random access configuration for random access in the SBFD resources. For example, 1304 may be performed by CU processor(s) 1512, DU processor(s) 1532, RU processor(s) 1542, transceiver(s) 1546, antenna(s) 1580, network processor 1612, network interface 1680, and/or SBFD RO component 199 of FIGS. 15 and 16. The random access configuration, in some aspects, may include multiple transmissions. For example, the random access configuration, in some aspects, may include a common RACH configuration and one or more dedicated RACH configurations. In some aspects, the random access configuration may include time and frequency information for SBFD RACH resources. The random access configuration, in some aspects, may indicate, or include, at least one random access configuration for random access in the SBFD resources.

In some aspects, the random access configuration may include and/or indicate one or more conditions such as a random access event trigger condition, a power condition, a UE type condition, or a conflicting signal condition. The random access event trigger condition, in some aspects, may be for random access in an RRC connected mode. In some aspects, the random access event trigger condition may be for a PDCCH scheduled random access transmission. The random access event trigger condition, in some aspects, may be for the PDCCH scheduled random access transmission for CFRA. In some aspects, the random access event trigger condition is for the PDCCH scheduled random access transmission for CFRA or CBRA. The random access event trigger condition, in some aspects, may be for a CFRA transmission with a reserved preamble associated with the random access in the SBFD resources and, in some aspects, may further be based on a PDCCH scheduled random access transmission. In some aspects, the random access event trigger condition may be based on a UE initiated random access transmission.

In some aspects, the power condition may be associated with one or more of a maximum transmission power of RACH transmissions, a reduced target receive power of a RACH transmission. The UE type condition, in some aspects, may be associated with cell-center UEs that are expected to measure an RSRP of a received DL signal (e.g., a received SSB) with at least a threshold power. Accordingly, the UE type condition may be associated with a measured RSPR of a signal associated with an RO being above an RSRP threshold for the random access in the SBFD resources. In some aspects, the conflicting signal condition may be based on, or associated with, the RO occurring in a symbol (or set of symbols) that does not include one or more of a SSB, a periodic CSI-RS, a PDCCH transmission, or a broadcast PDSCH transmission. The conflicting signal condition, in some aspects, may be based on the RO occurring in a symbol that does not include one or more of (1) the SSB when the UE is in an RRC idle state or an RRC connected state, (2) the periodic CSI-RS when the UE is in the RRC idle state or the RRC connected state, (3) the PDCCH transmission for when the UE is in the RRC idle state while monitoring for the broadcast PDSCH transmission or when the UE is in the RRC connected state, or (4) the broadcast PDSCH transmission that includes one or more of paging information, RMSI, or OSI.

In some aspects, the at least one random access configuration may include a repetition rule indicating (1) that repetitions of a first RACH message transmitted via either the SBFD resources or via non-SBFD uplink resources are allowed via the SBFD resources or the non-SBFD uplink resources (e.g., as in FIG. 17C), or (2) that repetitions of the first RACH message transmitted via the SBFD resources are not allowed via the non-SBFD uplink resources (e.g., as in FIG. 17A) and that repetitions of the first RACH message transmitted via the non-SBFD uplink resources are not allowed via the SBFD resources (e.g., as in FIG. 17B). For example, referring to FIG. 11, the base station 1102 may transmit SBFD RACH configuration messages 1118.

At 1306, the base station may receive, based on meeting one or more conditions of a random access event trigger condition, a power condition, a UE type condition, or a conflicting signal condition, a random access message in a RO in an uplink sub-band of an SBFD time period. For example, 1306 may be performed by CU processor(s) 1512, DU processor(s) 1532, RU processor(s) 1542, transceiver(s) 1546, antenna(s) 1580, network processor 1612, network interface 1680, and/or SBFD RO component 199 of FIGS. 15 and 16. In some aspects, the random access message may be a random access message in an RO in an uplink sub-band of an SBFD time period. The random access message, in some aspects, may be transmitted based on meeting one or more of the conditions included in the random access configuration received at 1304 (e.g., a random access event trigger condition, a power condition, a UE type condition, or a conflicting signal condition). In some aspects, transmitting the random access message may be based on the power condition and may include transmitting the random access message in the RO in the uplink sub-band with a transmission power that is below a power threshold (e.g., the first maximum transmission power 962) for the random access in the SBFD resources. The power threshold, in some aspects, may be a maximum PRACH transmission power (e.g., the first maximum transmission power 962) or may be based on, or associated with, a target PRACH receive power (e.g., target received power 963 for the SBFD RO transmission). In some aspects, transmitting the random access message may be based on the UE type condition and may include transmitting the RACH message 1122 in the RO in the uplink sub-band based on a measured RSRP of a signal associated with the RO being above an RSRP threshold for the random access in the SBFD resources. Transmitting the random access message, in some aspects, may be based on the conflicting signal condition and may include transmitting the random access message in uplink sub-band the RO that does not overlap in time with a downlink signal having a higher priority than the random access message. As described above, the conflicting signal condition may be based on the RO occurring in a symbol that does not include one or more of a SSB, a periodic CSI-RS, a PDCCH transmission, or a broadcast PDSCH transmission. For example, referring to FIG. 11, the base station 1102 may receive RACH message 1122.

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include at least one cellular baseband processor 1424 (also referred to as a modem) coupled to one or more transceivers 1422 (e.g., cellular RF transceiver). The cellular baseband processor(s) 1424 may include at least one on-chip memory 1424′. In some aspects, the apparatus 1404 may further include one or more subscriber identity modules (SIM) cards 1420 and at least one application processor 1406 coupled to a secure digital (SD) card 1408 and a screen 1410. The application processor(s) 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize one or more antennas 1480 for communication. The cellular baseband processor(s) 1424 communicates through the transceiver(s) 1422 via the one or more antennas 1480 with the UE 104 and/or with an RU associated with a network entity 1402. The cellular baseband processor(s) 1424 and the application processor(s) 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor(s) 1424 and the application processor(s) 1406 are each responsible for general processing, including the execution of software stored on the computer-readable medium/memory. The software, when executed by the cellular baseband processor(s) 1424/application processor(s) 1406, causes the cellular baseband processor(s) 1424/application processor(s) 1406 to perform the various functions described supra. The computer-readable medium/memory may also be used for storing data that is manipulated by the cellular baseband processor(s) 1424/application processor(s) 1406 when executing software. The cellular baseband processor(s) 1424/application processor(s) 1406 may be a component of the UE 450 and may include the at least one memory 460 and/or at least one of the TX processor 468, the RX processor 456, and the controller/processor 459. In one configuration, the apparatus 1404 may be at least one processor chip (modem and/or application) and include just the cellular baseband processor(s) 1424 and/or the application processor(s) 1406, and in another configuration, the apparatus 1404 may be the entire UE (e.g., see UE 450 of FIG. 4) and include the additional modules of the apparatus 1404.

As discussed supra, the SBFD RO component 198 may be configured to receive time and frequency information for SBFD resources, receive at least one random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period. The SBFD RO component 198 may be within the cellular baseband processor(s) 1424, the application processor(s) 1406, or both the cellular baseband processor(s) 1424 and the application processor(s) 1406. The SBFD RO component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1404 may include a variety of components configured for various functions. In one configuration, the apparatus 1404, and in particular the cellular baseband processor(s) 1424 and/or the application processor(s) 1406, may include means for receiving time and frequency information for sub-band full-duplex (SBFD) resources. The apparatus 1404, and in particular the cellular baseband processor(s) 1424 and/or the application processor(s) 1406, may include means for receiving at least one random access configuration for random access in the SBFD resources. The apparatus 1404, and in particular the cellular baseband processor(s) 1424 and/or the application processor(s) 1406, may include means for transmitting, based on meeting one or more conditions of a random access event trigger condition, a power condition, a UE type condition, or a conflicting signal condition, a random access message in a random access occasion (RO) in an uplink sub-band of an SBFD time period. The apparatus 1404, and in particular the cellular baseband processor(s) 1424 and/or the application processor(s) 1406, may include means for receiving an indication of a time division duplex (TDD) pattern of resources. The apparatus 1404 may further include means for performing any of the aspects described in connection with the flowcharts in FIG. 12, and/or performed by the UE in the communication flow of FIG. 11. The means may be the SBFD RO component 198 of the apparatus 1404 configured to perform the functions recited by the means. As described supra, the apparatus 1404 may include the TX processor 468, the RX processor 456, and the controller/processor 459. As such, in one configuration, the means may be the TX processor 468, the RX processor 456, and/or the controller/processor 459 configured to perform the functions recited by the means or as described in relation to FIGS. 11 and 12.

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the SBFD RO component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include at least one CU processor 1512. The CU processor(s) 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include at least one DU processor 1532. The DU processor(s) 1532 may include on-chip memory 1532′. In some aspects, the DU 1530 may further include additional memory modules 1534 and a communications interface 1538. The DU 1530 communicates with the RU 1540 through a fronthaul link. The RU 1540 may include at least one RU processor 1542. The RU processor(s) 1542 may include on-chip memory 1542′. In some aspects, the RU 1540 may further include additional memory modules 1544, one or more transceivers 1546, one or more antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SBFD RO component 199 may be configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period. The SBFD RO component 199 may be within one or more processors of one or more of the CU 1510, DU 1530, and the RU 1540. The SBFD RO component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1502 may include a variety of components configured for various functions. In one configuration, the network entity 1502 may include means for providing time and frequency information for sub-band full-duplex (SBFD) resources. In one configuration, the network entity 1502 may include means for providing a random access configuration for random access in the SBFD resources, wherein the random access configuration is associated with one or more conditions of a random access event trigger condition, a power condition, or a conflicting signal condition. In one configuration, the network entity 1502 may include means for providing an indication of a time division duplex (TDD) pattern of resources. The network entity 1502 may further include means for performing any of the aspects described in connection with the flowcharts in FIG. 13, and/or performed by the base station in the communication flow of FIG. 11. The means may be the SBFD RO component 199 of the network entity 1502 configured to perform the functions recited by the means. As described supra, the network entity 1502 may include the TX processor 416, the RX processor 470, and the controller/processor 475. As such, in one configuration, the means may be the TX processor 416, the RX processor 470, and/or the controller/processor 475 configured to perform the functions recited by the means or as described in relation to FIGS. 11 and 13.

FIG. 16 is a diagram 1600 illustrating an example of a hardware implementation for a network entity 1660. In one example, the network entity 1660 may be within the core network 220. The network entity 1660 may include at least one network processor 1612. The network processor(s) 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The network processor(s) 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the SBFD RO component 199 may be configured to provide time and frequency information for SBFD resources and provide at least one random access configuration for random access in the SBFD resources, where the random access configuration is associated with one or more conditions of a random access event trigger condition, a power condition, a UE type condition, or a conflicting signal condition for transmitting a random access message in a random access occasion (RO) in an uplink sub-band of an SBFD time period. The SBFD RO component 199 may be within the network processor(s) 1612. The SBFD RO component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1660 may include a variety of components configured for various functions. In one configuration, the network entity 1660 may include means for providing time and frequency information for sub-band full-duplex (SBFD) resources. In one configuration, the network entity 1660 may include means for providing a random access configuration for random access in the SBFD resources, wherein the random access configuration is associated with one or more conditions of a random access event trigger condition, a power condition, or a conflicting signal condition. In one configuration, the network entity 1660 may include means for providing an indication of a time division duplex (TDD) pattern of resources. The network entity 1660 may further include means for performing any of the aspects described in connection with the flowcharts in FIG. 13, and/or performed by the base station in the communication flow of FIG. 11. The means may be the SBFD RO component 199 of the network entity 1660 configured to perform the functions recited by the means. As described supra, the network entity 1660 may include the TX processor 416, the RX processor 470, and the controller/processor 475. As such, in one configuration, the means may be the TX processor 416, the RX processor 470, and/or the controller/processor 475 configured to perform the functions recited by the means or as described in relation to FIGS. 11 and 13.

Various aspects relate generally to limiting UE-to-UE CLI associated with the use of SBFD ROs. Some aspects more specifically relate to different options to specify RACH occasion behavior for connected UEs within SBFD symbols. For example, some options may be summarized as allowing connected UEs to use SBFD ROs, using controlled PRACH (e.g., PDCCH ordered PRACH), specifying behaviors of non-SBFD-capable UEs, limiting PRACH transmit power, and limiting power by applying a minimum RSRP for a DL transmission before an SBFD-capable UE may use SBFD ROs. In some examples, a wireless device or UE configured to receive time and frequency information for SBFD resources, receive a random access configuration for random access in the SBFD resources, and transmit, based on meeting one or more conditions of a random access event trigger condition, a power condition, a UE type condition, or a conflicting signal condition, a random access message in a RO in an uplink sub-band of an SBFD time period. In some examples, a network device or base station configured to provide time and frequency information for SBFD resources and provide a random access configuration for random access in the SBFD resources, where the random access configuration is associated with one or more conditions of a random access event trigger condition, a power condition, or a conflicting signal condition for transmitting a random access message in a random access occasion (RO) in an uplink sub-band of an SBFD time period.

Particular aspects of the subject matter described in this disclosure can be implemented to realize one or more of the following potential advantages. In some examples, by configuring the use of SBFD ROs, the described techniques can be used to enhance UL coverage, reduce RACH collision probability, reduce random access latency.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: receiving time and frequency information for sub-band full-duplex (SBFD) resources; receiving at least one random access configuration for random access in the SBFD resources; and transmitting, based on meeting one or more conditions of a random access event trigger condition, a power condition, a UE type condition, or a conflicting signal condition, a random access message in a random access occasion (RO) in an uplink sub-band of an SBFD time period.

Aspect 2 is the method of aspect 1, wherein the SBFD resources are for full-duplex operation of a network node, and wherein the SBFD time period includes one or more symbols or one or more slots.

Aspect 3 is the method of any of aspects 1 and 2, wherein transmitting the random access message includes transmitting the random access message in the RO in the uplink sub-band based on meeting at least the random access event trigger condition.

Aspect 4 is the method of aspect 3, wherein the random access event trigger condition is for random access in a radio resource control (RRC) connected mode.

Aspect 5 is the method of aspect 4, wherein the random access event trigger condition is for a physical downlink control channel (PDCCH) scheduled random access transmission.

Aspect 6 is the method of aspect of 5, wherein the random access event trigger condition is for the PDCCH scheduled random access transmission for contention free random access (CFRA) random access.

Aspect 7 is the method of aspect of 5, wherein the random access event trigger condition is for the PDCCH scheduled random access transmission for contention free random access (CFRA) random access or contention based random access (CBRA) random access.

Aspect 8 is the method of any of aspects 1 to 4, wherein the random access event trigger condition is for a contention free random access (CFRA) random access transmission with a reserved preamble associated with the random access in the SBFD resources.

Aspect 9 is the method of aspect 8, wherein the random access event trigger condition is further based on a physical downlink control channel (PDCCH) scheduled random access transmission.

Aspect 10 is the method of 8, wherein the random access event trigger condition is further based on a UE initiated random access transmission.

Aspect 11 is the method of any of aspects 1 to 10, wherein transmitting the random access message is based on the power condition and includes transmitting the random access message in the RO in the uplink sub-band with a transmission power that is below a power threshold for the random access in the SBFD resources.

Aspect 12 is the method of aspect 11, wherein the power threshold comprises a maximum physical random access channel (PRACH) transmission power or is based on a reduced target PRACH receive power.

Aspect 13 is the method of any of aspects 1 to 12, wherein transmitting the random access message is based on the UE type condition associated with a measured reference signal received power (RSRP) of a signal associated with the RO being above an RSRP threshold for the random access in the SBFD resources.

Aspect 14 is the method of any of aspects 1 to 13, wherein transmitting the random access message is based on the conflicting signal condition and includes transmitting the random access message in uplink sub-band the RO that does not overlap in time with a downlink signal having a higher priority than the random access message.

Aspect 15 is the method of aspect 14, wherein the conflicting signal condition is based on the RO occurring in a symbol that does not include one or more of: a synchronization signal block (SSB), a periodic channel state information reference signal (CSI-RS), a physical downlink control channel (PDCCH) transmission, or a broadcast physical downlink shared channel (PDSCH) transmission.

Aspect 16 is the method of aspect 15, wherein the conflicting signal condition is based on the RO occurring in a symbol that does not include one or more of: the SSB when the UE is in a radio resource control (RRC) idle state or an RRC connected state, the periodic CSI-RS when the UE is in the RRC idle state or the RRC connected state, the PDCCH transmission for when the UE is in the RRC idle state while monitoring for the broadcast PDSCH transmission or when the UE is in the RRC connected state, or the broadcast PDSCH transmission that includes one or more of paging information, remaining system information (RMSI), or other system information (OSI).

Aspect 17 is the method of any of aspects 1 to 16, wherein the at least one random access configuration comprises a repetition rule indicating: that repetitions of a first RACH message transmitted via either the SBFD resources or via non-SBFD uplink resources are allowed via the SBFD resources or the non-SBFD uplink resources; or that repetitions of the first RACH message transmitted via the SBFD resources are not allowed via the non-SBFD uplink resources and that repetitions of the first RACH message transmitted via the non-SBFD uplink resources are not allowed via the SBFD resources.

Aspect 18 is a method of wireless communication at a network node, comprising: providing time and frequency information for sub-band full-duplex (SBFD) resources; and providing at least one random access configuration for random access in the SBFD resources, wherein the random access configuration is associated with one or more conditions of a random access event trigger condition, a power condition, a UE type condition, or a conflicting signal condition for transmitting a random access message in a random access occasion (RO) in an uplink sub-band of an SBFD time period.

Aspect 19 the method of aspect 18, wherein the SBFD resources are for full-duplex operation of a network node, and wherein the SBFD time period includes one or more symbols or one or more slots.

Aspect 20 the method of any of aspects 18 and 19, further comprising: receiving a random access message in the RO in the uplink sub-band based on at least the random access event trigger condition.

Aspect 21 the method of aspect 20, wherein the random access event trigger condition is for random access in a radio resource control (RRC) connected mode.

Aspect 22 the method of aspect 21, wherein the random access event trigger condition is for a physical downlink control channel (PDCCH) scheduled random access transmission.

Aspect 23 the method of aspect 22, wherein the random access event trigger condition is for the PDCCH scheduled random access transmission for contention free random access (CFRA) random access.

Aspect 24 the method of aspect 22, wherein the random access event trigger condition is for the PDCCH scheduled random access transmission for contention free random access (CFRA) random access or contention based random access (CBRA) random access.

Aspect 25 the method of any of aspects 18-21, wherein the random access event trigger condition is for a contention free random access (CFRA) random access transmission with a reserved preamble associated with the random access in the SBFD resources.

Aspect 26 the method of aspect 25, wherein the random access event trigger condition is further based on a physical downlink control channel (PDCCH) scheduled random access transmission.

Aspect 27 the method of aspect 25, wherein the random access event trigger condition is further based on a UE initiated random access transmission.

Aspect 28 the method of any of aspects 18 to 27, further comprising: receiving a random access message in the RO in the uplink sub-band with a transmission power that is below a power threshold for the random access in the SBFD resources.

Aspect 29 the method of aspect 28, wherein the power threshold comprises a maximum physical random access channel (PRACH) transmission power or is based on a reduced target PRACH receive power.

Aspect 30 the method of any of aspects 18 to 29, further comprising: receiving a random access message in the RO in the uplink sub-band based on the UE type condition associated with a measured reference signal received power (RSRP) of a signal associated with the RO being above an RSRP threshold for the random access in the SBFD resources.

Aspect 31 the method of any of aspects 18 to 30, further comprising: receiving a random access message in the uplink sub-band in the RO that does not overlap in time with a downlink signal having a higher priority than the random access message.

Aspect 32 the method of aspect 31, wherein the conflicting signal condition is based on the RO occurring in a symbol that does not include one or more of: a synchronization signal block (SSB), a periodic channel state information reference signal (CSI-RS), a physical downlink control channel (PDCCH) transmission, or a broadcast physical downlink shared channel (PDSCH) transmission.

Aspect 33 the method of aspect 32, wherein the conflicting signal condition is based on the RO occurring in a symbol that does not include one or more of: the SSB when the UE is in a radio resource control (RRC) idle state or an RRC connected state, the periodic CSI-RS when the UE is in the RRC idle state or the RRC connected state, the PDCCH transmission for when the RRC idle state while monitoring for the broadcast PDSCH transmission or when the UE is in the RRC connected state, or the broadcast PDSCH transmission that includes one or more of paging information, remaining system information (RMSI), or other system information (OSI).

Aspect 34 the method of any of aspects 18 to 33, wherein the at least one random access configuration comprises a repetition rule indicating: that repetitions of a first RACH message transmitted via either the SBFD resources or via non-SBFD uplink resources are allowed via the SBFD resources or the non-SBFD uplink resources; or that repetitions of the first RACH message transmitted via the SBFD resources are not allowed via the non-SBFD uplink resources and that repetitions of the first RACH message transmitted via the non-SBFD uplink resources are not allowed via the SBFD resources.

Aspect 35 is an apparatus for wireless communication at a device including a memory and at least one processor coupled to the memory and, based at least in part on information stored in the memory, the at least one processor is configured to implement any of aspects 1 to 17.

Aspect 36 is the apparatus of aspect 35, further including a transceiver or an antenna coupled to the at least one processor.

Aspect 37 is an apparatus for wireless communication at a device including means for implementing any of aspects 1 to 17.

Aspect 38 is a computer-readable medium (e.g., a non-transitory computer-readable medium) storing computer executable code, where the code when executed by a processor causes the processor to implement any of aspects 1 to 17.

Aspect 39 is an apparatus for wireless communication at a device including a memory and at least one processor coupled to the memory and, based at least in part on information stored in the memory, the at least one processor is configured to implement any of aspects 18 to 34.

Aspect 40 is the apparatus of aspect 39, further including a transceiver or an antenna coupled to the at least one processor.

Aspect 41 is an apparatus for wireless communication at a device including means for implementing any of aspects 18 to 34.

Aspect 42 is a computer-readable medium (e.g., a non-transitory computer-readable medium) storing computer executable code, where the code when executed by a processor causes the processor to implement any of aspects 18 to 34.

What is claimed is:

1. An apparatus for wireless communication at a user equipment (UE), comprising:
one or more memories; and
one or more processors coupled to the one or more memories, wherein the one or more processors, individually or in any combination, are configured to cause the UE to:
receive time and frequency information for sub-band full-duplex (SBFD) resources;
receive at least one random access configuration for random access in the SBFD resources; and
transmit, based on meeting one or more conditions of a random access event trigger condition, a power condition, a UE type condition, or a conflicting signal condition, a random access message in a random access occasion (RO) in an uplink sub-band of an SBFD time period.

2. The apparatus of claim 1, wherein the SBFD resources are for full-duplex operation of a network node, and wherein the SBFD time period includes one or more symbols or one or more slots.

3. The apparatus of claim 1, wherein to transmit the random access message the one or more processors, individually or in any combination, are configured to transmit the random access message in the RO in the uplink sub-band based on meeting at least the random access event trigger condition.

4. The apparatus of claim 3, wherein the random access event trigger condition is for random access in a radio resource control (RRC) connected mode.

5. The apparatus of claim 4, wherein the random access event trigger condition is for a physical downlink control channel (PDCCH) scheduled random access transmission.

6. The apparatus of claim 5, wherein the random access event trigger condition is for the PDCCH scheduled random access transmission for contention free random access (CFRA) random access.

7. The apparatus of claim 5, wherein the random access event trigger condition is for the PDCCH scheduled random access transmission for contention free random access (CFRA) random access or contention based random access (CBRA) random access.

8. The apparatus of claim 4, wherein the random access event trigger condition is for a contention free random access (CFRA) random access transmission with a reserved preamble associated with the random access in the SBFD resources.

9. The apparatus of claim 8, wherein the random access event trigger condition is further based on a physical downlink control channel (PDCCH) scheduled random access transmission.

10. The apparatus of claim 8, wherein the random access event trigger condition is further based on a UE initiated random access transmission.

11. The apparatus of claim 1, wherein to transmit the random access message the one or more processors, individually or in any combination, are configured to transmit the random access message based on the power condition and to transmit the random access message in the RO in the uplink sub-band with a transmission power that is below a power threshold for the random access in the SBFD resources.

12. The apparatus of claim 11, wherein the power threshold comprises a maximum physical random access channel (PRACH) transmission power or is based on a reduced target PRACH receive power.

13. The apparatus of claim 1, wherein to transmit the random access message the one or more processors, individually or in any combination, are configured to transmit the random access message based on the UE type condition associated with a measured reference signal received power (RSRP) of a signal associated with the RO being above an RSRP threshold for the random access in the SBFD resources.

14. The apparatus of claim 1, to transmit the random access message the one or more processors, individually or in any combination, are configured to transmit the random access message based on the conflicting signal condition and to transmit the random access message in the uplink sub-band the RO that does not overlap in time with a downlink signal having a higher priority than the random access message.

15. The apparatus of claim 14, wherein the conflicting signal condition is based on the RO occurring in a symbol that does not include one or more of:
a synchronization signal block (SSB),
a periodic channel state information reference signal (CSI-RS),
a physical downlink control channel (PDCCH) transmission, or
a broadcast physical downlink shared channel (PDSCH) transmission.

16. The apparatus of claim 15, wherein the conflicting signal condition is based on the RO occurring in a symbol that does not include one or more of:
the SSB when the UE is in a radio resource control (RRC) idle state or an RRC connected state,
the periodic CSI-RS when the UE is in the RRC idle state or the RRC connected state,
the PDCCH transmission for when the UE is in the RRC idle state while monitoring for the broadcast PDSCH transmission or when the UE is in the RRC connected state, or
the broadcast PDSCH transmission that includes one or more of paging information, remaining system information (RMSI), or other system information (OSI).

17. The apparatus of claim 1, wherein the at least one random access configuration comprises a repetition rule indicating:
that repetitions of a first RACH message transmitted via either the SBFD resources or via non-SBFD uplink resources are allowed via the SBFD resources or the non-SBFD uplink resources; or
that repetitions of the first RACH message transmitted via the SBFD resources are not allowed via the non-SBFD uplink resources and that repetitions of the first RACH message transmitted via the non-SBFD uplink resources are not allowed via the SBFD resources.

18. An apparatus for wireless communication at a network node, comprising:
one or more memories; and
one or more processors coupled to the one or more memories, wherein the one or more processors, individually or in any combination, are configured to cause the network node to:
provide time and frequency information for sub-band full-duplex (SBFD) resources; and
provide at least one random access configuration for random access in the SBFD resources, wherein the random access configuration is associated with one or more conditions of a random access event trigger condition, a power condition, a UE type condition, or a conflicting signal condition for transmitting a random access message in a random access occasion (RO) in an uplink sub-band of an SBFD time period.

19. The apparatus of claim 18, wherein the SBFD resources are for full-duplex operation of a network node, and wherein the SBFD time period includes one or more symbols or one or more slots.

20. The apparatus of claim 18, wherein the at least one random access configuration comprises a repetition rule indicating:
that repetitions of a first RACH message transmitted via either the SBFD resources or via non-SBFD uplink resources are allowed via the SBFD resources or the non-SBFD uplink resources; or
that repetitions of the first RACH message transmitted via the SBFD resources are not allowed via the non-SBFD uplink resources and that repetitions of the first RACH message transmitted via the non-SBFD uplink resources are not allowed via the SBFD resources.
